(19) United States
(12) Patent Application Publication
(10) Pub. No.: US 2024/0170754 A1
(43) Pub. Date: May 23, 2024

(54) DIRECTLY COOLED BATTERY MODULE AND BATTERY WITH A DIRECTLY COOLED BATTERY MODULE

(71) Applicant: Dr. Ing. h.c. F. Porsche Aktiengesellschaft, Stuttgart (DE)

(72) Inventor: Arnold Lamm, Elchingen (DE)

(73) Assignee: Dr. Ing. h.c. F. Porsche Aktiengesellschaft, Stuttgart (DE)

(21) Appl. No.: 18/280,993

(22) PCT Filed: Mar. 4, 2022
(86) PCT No.: PCT/EP2022/055573

§ 371 Date: Sep. 8, 2023

(30) Foreign Application Priority Data
Mar. 10, 2021 (DE) 10 2021 105 861.9

(51) Int. Cl. H01M 10/613; H01M 10/647; H01M 10/6568

(52) U.S. Cl. CPC H01M 10/613; H01M 10/647; H01M 10/6568

(57) ABSTRACT

A directly cooled battery module including at least one module casing and a plurality of battery cells arranged within the module casing. The module casing encloses the plurality of battery cells at least in some regions, and the battery cells have a vertical axis and first and second end faces, which are mutually spaced in the direction of the vertical axis, and are arranged successively in the form of a cell packet in a stacking direction which is transverse to the vertical axis. The battery module also includes a fluid supply device with at least one inlet opening, which conducts a cooling liquid to the battery cells when operated as intended, and at least one outlet opening for freely discharging the cooling liquid out of the module casing and/or the cell packet and into the surroundings of the module casing or a battery housing.

### CROSS-REFERENCE TO RELATED APPLICATIONS

This application claims priority to PCT International Patent Application No. PCT/EP2022/055573, filed Mar. 4, 2022, which claims priority to German Patent Application No. 10 2021 105 861.9, filed Mar. 10, 2021, the content of such application being incorporated by reference herein in its entirety.

### FIELD OF THE INVENTION

The invention relates to a directly cooled battery module and a battery comprising at least one directly cooled battery module, in particular for an electrically driven vehicle.

### BACKGROUND OF THE INVENTION

High-voltage batteries for electrically driven vehicles, such as hybrid, plug-in or electric vehicles, or for stationary applications, such as power suppliers or power storage systems, consist of many individual cells electrically connected in series and/or in parallel.

Within a battery, the individual cells are typically grouped together in so-called battery modules which each contain a specific number of battery cells as a cell packet, including the means for mechanically securing them, for providing electrical contact and for temperature control (cooling, heating). The battery modules, typically 8 to 36 battery modules per battery, are in turn housed in a stable battery housing, which additionally contains the necessary means for electrically controlling and protecting the battery, such as a battery management system (BMS), fuses, contactors for switching the current on and off, cell supervision electronics (CSE), ammeters and the connections to the outside (current supply line and current discharge line, coolant feed and coolant discharge, connection, battery control and the like).

In the case of particularly high cooling requirements for large charge and discharge currents, possibly in conjunction with high electrical internal resistances of the cells, it is useful if the coolant flows directly around the cells, so-called direct cooling. Since the surfaces of the cell housing, or parts of the cell housing, usually carry voltage or potential, an electrically non-conductive coolant is used. The use of special oils such as transformer oil, silicone oil and the like, or special hydrofluorocarbons (HFCs), for instance, is known. Hydrofluorocarbons are available with different boiling points, so that not only a simple immersion bath cooling, but also a boiling bath cooling, can be implemented.

To ensure direct cooling, each battery module is typically configured with a module housing that is sealed on all sides as a module casing and is provided with a coolant supply line and a coolant discharge line as well as with sealed passages through the module casing, in particular for the current supply line and the current discharge line, the signal leads for the cell voltages, which lead to the CSE or to a means for measuring the cell voltage and equalizing the state of charge, so-called balancing, and for sensor leads, for example for temperature monitoring within the battery module.

### SUMMARY OF THE INVENTION

The object of the invention is to create an improved structure for a directly cooled battery module.

A further object is to create a battery comprising at least one directly cooled battery module which has an improved structure of the battery module.

The objects are achieved by the features of the independent claims. Favorable configurations and advantages of the invention will emerge from the further claims, the description and the drawing.

According to one aspect of the invention, a directly cooled battery module comprising at least one module casing and a plurality of battery cells disposed inside the module casing is proposed, wherein the module casing encloses the plurality of battery cells at least in some regions, wherein the battery cells comprise a vertical axis and first and second end faces which are spaced apart from one another in the direction of the vertical axis and disposed successively in the form of a cell packet in a stacking direction transverse to the vertical axis. The battery module comprises a fluid supply device having at least one inlet opening, which, in intended operation, conducts a cooling liquid onto the battery cells. The battery module further comprises at least one outlet opening for freely discharging the cooling liquid from the module casing and/or the cell packet into the surroundings of the module casing; when disposed as intended in a battery housing, in particular into the battery housing.

The battery module according to the invention has the advantage that there is no need for a hermetically sealed module casing. This facilitates the construction of battery modules. Such a configuration moreover makes it possible to simplify the safety devices of the battery modules and optionally also of the batteries.

The tightness of the battery modules, which can only be achieved with considerable technical effort and which, in the case of direct cooling with HFCs, is particularly complex because said HFCs can diffuse through any type of plastic casing or plastic seal and have to therefore continuously be replenished, can thus be dispensed with.

Since there is therefore no longer any overpressure, or only very little, in the interior of the battery module relative to the surroundings, the module casing can be designed to be simpler and less stable. The overpressure is a result of the pump output required to maintain the flow of coolant. The pressure loss when flow passes over the first and/or second end faces, in particular the connecting elements, is low. Thus, when the cooling liquid flows freely into a lower part of the housing configured as a trough, a necessary low overpressure of at most 100 mbar can be assumed. If, in another design example, the cooling liquid has to flow back underneath the cell packet at the base of the battery module and via a channel structure into an equalizing container, a necessary low overpressure of at most 500 mbar can be assumed.

The coolant also no longer has to be conducted between the supply and the discharge connectors through complex distribution, collection and guide means to achieve even cooling of all of the individual cells of a battery module.

Among other things when the battery cell is overcharged or short-circuited, pressure can build up in the interior of the cell that has to be reduced in a defined manner when it exceeds a specific value in order to prevent an exothermic reaction of the cell chemistry with corresponding thermal propagation in the battery module and further in the battery. The gas produced in this process, e.g., due to evaporation of the electrolyte, is referred to as venting gas.

In this case, the module casing of the battery module according to the invention no longer has to be provided with overpressure devices, such as valves, membranes or flaps, the so-called venting means, to prevent the destruction of a sealed module housing when cells vent. This makes it possible to further reduce costs and installation space requirements for the battery module.

To reduce the costs, the weight and the installation space requirements, and for better heat dissipation with increased safety against thermal propagation, the electrically non-conductive cooling liquid can be fed to the battery module via lines, distributed within the battery module and then, for a defined escaping of the cooling liquid, freely escape to the outside via at least one outlet opening in the module casing.

The coolant escaping from the battery modules into the battery housing during normal operation is then collected or suctioned off there and can be fed back into the coolant circuit.

With the battery module according to the invention, only the battery housing itself has to be sealed, which is usually already implemented in this way to shield the battery modules from environmental effects. The plurality of module housings of the battery modules disposed in the battery housing do not, however, which reduces the costs, the weight and the installation space requirements. In particular the lines for supplying and discharging current, and the signal and measuring leads, can be routed through simple openings or perforations in the module casing, which eliminates the need for extensive sealing. Since the interior of the module is virtually pressureless, the construction of the casing can be significantly more lightweight.

Additional venting means in the module housing that open only in the event of internal overpressure, such as overpressure valves, overpressure diaphragms or overpressure flaps, are not required.

This solution furthermore eliminates the need for the otherwise customary coolant discharge lines in the battery, which collect the coolant from the battery modules and feed it to the cooling circuit of the battery. There is also no need for a separate level-controlled tank or reservoir for the coolant. This function can be carried out by the lower part of the battery housing.

A transverse axis can advantageously be configured between the connecting elements of the battery cells, in particular transverse to the vertical axis and transverse to the stacking direction. The connecting elements are located in a longitudinal extension of the battery cell on the first end face of the battery cell. This corresponds to so-called prismatic battery cells. Cylindrical battery cells (round cells) or so-called pouch cells are conceivable too, however.

According to one advantageous configuration of the battery module, at least one fluid channel can be disposed inside the module casing in an end plate between the first end face and the second end face of the battery cells. An already existing installation space can advantageously be used to conduct the cooling liquid, so that the structure of the battery module can be relatively small. There is no need for additional piping for conducting the cooling liquid.

According to one advantageous configuration of the battery module, the at least one inlet opening can be disposed in one of the end plates, in particular near the underside of the module casing. The battery module is conveniently disposed between two end plates and clamped between them.

The cooling liquid can advantageously rise in the end plate to the end face comprising the electrical connectors, flow over the connections there and flow in the opposite end plate to the opposite end face. The flow can advantageously pass over the battery cells at the electrical connecting elements and cell connectors, where most of the heat in the battery cells is produced, and cool them particularly effectively.

There is no need for additional piping for conducting the cooling liquid. Alternatively, it is also possible for the inlet opening into the end plate to be disposed from the underside of the end plate and/or from the underside of the module casing.

According to one advantageous configuration of the battery module, the at least one outlet opening can be disposed on the underside of the module casing. There, the cooling liquid can freely escape into the surroundings of the module casing. The at least one outlet opening can conveniently be disposed near the end plate comprising the at least one inlet opening, so that the cooling liquid can flow between the module casing and the battery cells and further dissipate heat. There is no need for additional piping for conducting the cooling liquid. In this case, the cooling liquid flows over the battery cells on the first end face in the region of the electrical connecting elements and flows under the battery cells on the second end face at the base of the battery cells. This makes it possible to achieve advantageous dissipation of the heat loss from the battery cells, since the heat loss occurs largely in the region of the connecting elements.

According to one advantageous configuration of the battery module, the fluid supply device can comprise a distribution line having a plurality of inlet openings.

The fluid supply device can in particular comprise at least one inlet opening per battery cell, in particular per electrical connecting element of the battery cells. The cooling liquid can thus conveniently be distributed over a large area inside the battery module in order to achieve particularly effective cooling of the battery cells. Advantageously, at least one inlet opening per electrical connecting element of the battery cells can be provided for the cooling liquid from the distribution line into the interior of the battery module. The inlet opening can expediently be provided in the immediate vicinity of a connecting element, for example directly opposite a connecting element. Alternatively or additionally, a plurality of outlet openings can be provided.

In this case, it is sufficient if there is at least one outlet opening for the defined discharge of the cooling liquid and further outlet openings, in the form of unsealed perforations, openings and gaps, for example for cables and sensor leads and the like, are provided in the casing, through which a further small portion of the cooling liquid can escape in an undefined manner.

According to one advantageous configuration of the battery module, the fluid supply device can be configured for targeted distribution of the cooling liquid over at least one of the two end faces of the battery cells in the cell packet. In particular the fluid supply device can be configured for targeted distribution of the cooling liquid over the electrical connecting elements of the battery cells in the cell packet. The cooling liquid can thus conveniently be distributed over a large area inside the battery module over an end face of the battery cells, preferably the end face comprising the electrical connecting elements, in order to achieve particularly effective cooling of the connecting elements. This advantageously makes it possible to achieve efficient dissipation of the heat, because the heat in a battery cell is typically produced in the region of the connecting elements.

According to one advantageous configuration of the battery module, the fluid supply device can comprise a nozzle assembly that sprays the cooling liquid onto the cell packet. The cooling liquid can be thus be distributed over a large area, for example on the end face of the battery cells, in particular those comprising the connecting elements, in order to achieve the most effective possible cooling of the battery cells at the point of origin of the heat, namely at the connecting elements.

According to one advantageous configuration of the battery module, at least one fluid channel can be disposed inside the module casing between the first end face and the second end face of the battery cells in the cell packet. The cooling liquid that flows or stands in the at least one fluid channel can be used for areal cooling on longitudinal sides or peripheral sides of the battery cells. Further favorable heat dissipation can take place via an areal flow over the electrical connecting elements on the first end face without the presence of an explicitly configured fluid channel. A filling body, for example in the form of a blister, can advantageously be disposed in the region between the electrical connecting elements along the cell packet, so that the cooling liquid flows on both sides of the filling body substantially over the electrical connecting elements. If venting openings are disposed in the cell housings between the connecting elements, a filling body can still be disposed above them. For this purpose, the filling body can expediently comprise suitable recesses at the location of the venting openings, through which escaping gas can flow out. The filling body promotes suitable flow of the cooling liquid over the electrical connecting elements for the greatest possible dissipation of heat at the point of origin, since the heat loss occurs largely in the region of the connecting elements. The filling body also reduces the free volume in the battery module, so that a smaller volume of cooling liquid is needed.

Especially in the event of increased heat generation in a battery cell, for example as a result of overcharging or an internal short circuit, the cooling liquid can moreover prevent or at least reduce thermal propagation caused by the heat, because the heat can thus be dissipated particularly effectively via flow or convection.

According to one advantageous configuration of the battery module, a liquid-permeable layer, in particular a porous adhesive mat, can be disposed at least partly between the battery cells in the direction of the vertical axis. Alternatively, a channel structure can be disposed, which comprises channels that extend from one end face to the other end face of the battery cells in the cell packet and can extend parallel or at an angle to the vertical axis, wherein the channels can be parallel or oblique to the vertical axis, wherein the channels are configured such that, at least in some regions, they are continuous or, at least in some regions, they are blind channels. The cooling liquid can be in the liquid-permeable layer or the channel structure between the battery cells, or can even flow through the channels. The cooling liquid can thus be used for areal cooling on the longitudinal sides or peripheral sides of the battery cells. Especially in the event of increased heat generation in a battery cell, for example as a result of overcharging or an internal short circuit, the cooling liquid can moreover prevent or at least reduce thermal propagation caused by the heat, because the heat can thus be dissipated particularly effectively via flow or convection.

A porous foam mat or a rubber-like press mat comprising channels can advantageously be disposed between the battery cells as a liquid-permeable layer that fills with cooling liquid when the battery is put into operation. In the event of thermal propagation of the battery, this provides an additional advantage.

An exothermic reaction in a battery cell in the battery module involving venting of the produced gas on the first end face directly into the cooling liquid leads to so-called capacitive cooling, in which the thermal energy is not dissipated, but is instead absorbed and stored by the surrounding material, and, in the extreme case, to evaporative cooling between the defective battery cell and the two neighboring cells, and also the first or second end face exposed to coolant or optionally the longitudinal sides of the defective battery cell which are exposed to coolant.

This makes it possible to prevent an unwelcome sharp rise in the temperature in the two neighboring cells of the defective battery cell. Thermal propagation in the battery module and the battery as a whole can advantageously be prevented. The venting gas can moreover combine with a portion of the vaporized cooling liquid and be safely discharged into the battery via a venting mechanism outside the battery module.

A gas mixture created when electrolyte gas and cooling liquid are combined is typically far less combustible than the pure electrolyte gas. Direct ignition above the battery cells can thus also be prevented by the cooling liquid. Sparking, which causes the electrolyte gas to ignite, can be prevented. The cooling liquid can extinguish the defective ignited battery cell. The harmful process can stop.

According to one advantageous configuration of the battery module, the inlet openings for the cooling liquid can be disposed directed toward the first end faces such that the cooling liquid escapes from the inlet openings onto the first end faces. The outlet openings can be disposed on the opposite side of the cell packet with respect to the vertical axis. In the case of battery cells which are upright with the first end face comprising the connecting elements on the upper side, the cooling liquid can enter on the upper side and flow down between the battery cells due to gravity and thus freely escape from the battery module on the underside. This allows the battery cells to be cooled particularly effectively.

According to one advantageous configuration of the battery module, the inlet openings can be disposed directed toward the second end faces such that the cooling liquid escapes from the inlet openings onto the second end faces. The outlet openings can be disposed on the opposite side of the cell packet with respect to the vertical axis. In an alternative embodiment, the cooling liquid can also be fed to the underside of the battery module, rise along the longitudinal sides of the battery cells and escape from the battery module on the upper side.

According to one advantageous configuration of the battery module, with respect to the vertical axis, the fluid supply device can be disposed on the side of the cell packet comprising the first end faces or on the side of the cell packet comprising the second end faces. The fluid supply device can expediently be disposed on the side of the cell packet where the heat is produced so as to be able to dissipate the heat particularly effectively.

According to one advantageous configuration of the battery module, the outlet openings can be disposed laterally in the module casing at a height of the vertical axis between the first and second end faces of the battery cells in the cell packet. A lower part of the battery module can thus be flooded with the cooling liquid, which can flow back out of module casing through overflow openings as cooling liquid continues to flow in. As a result, there is always a certain quantity of cooling liquid in the battery module, which, in the event of a sudden demand for cooling, can serve as a reservoir. Passages for electrical leads can also be provided as outlet openings.

According to one advantageous configuration of the battery module, the module casing can be configured as a wall which extends around the vertical axis of the cell packet, in particular as a band or frame. The module casing can thus serve as a module frame, for instance, which, as a result of cell thickness growth due to cyclic charging and discharging and/or cell aging, can apply the pressure necessary to operate the battery cells. In the battery module according to the invention such a module frame does not have to be hermetically sealed, which enables an advantageous and inexpensive design.

According to one advantageous configuration of the battery module, the module casing can comprise a wall which extends around the vertical axis of the cell packet and at least one at least largely closed upper side on the side of the cell packet comprising the first end faces. The fluid supply device can be disposed on the side of the cell packet comprising the second end faces and the outlet openings can be disposed in the upper side.

In this embodiment, the cooling liquid can be fed into the battery module from the underside and escape on the upper side through the outlet openings. In this way, even in the event that a battery cell vents, escaping venting gas can combine directly with the cooling liquid and escape through the nearby outlet openings on the upper side of the battery module, which ensures increased safety in the operation of the battery module.

According to one advantageous configuration of the battery module, the outlet openings can have a cross-section which is configured such that a higher pressure loss for the cooling liquid occurs at the outlet openings than at the inlet openings and in a further course of a flow of the cooling liquid between the inlet openings and the outlet openings.

A channel having a generously proportioned cross-section through which the cooling liquid can flow in over the entire area without significant restriction can particularly advantageously be configured in the battery module as an extension of a short connecting piece of the fluid supply device, for instance, wherein the even distribution in the battery module then takes place without additional guide means through the outlet openings, which are designed as restrictors with a small cross-section and are disposed accordingly.

According to one advantageous configuration of the battery module, filling bodies can be disposed in the interior of the module casing, in particular in the region of the fluid supply device and/or a fluid discharge. The quantity of cooling liquid in the interior of the battery module can thus be reduced by filling bodies placed into the cavities, for example in the form of closed cell foams, plastic hollow bodies, and the like.

According to one advantageous configuration of the battery module, a cell connector unit and/or a cover can be disposed on the side of the cell packet comprising the first end faces of the battery cells, wherein the fluid supply device can be integrated in the cell connector unit and/or the cover. A cell connector unit, which is usually present anyway and combines the metallic cell connectors into one component, can thus be used to distribute the cooling liquid. For this purpose, plastic films of a top layer and a bottom layer of the cell connector unit can be glued or welded together. The two layers, which enclose the cell connectors from above and below, can be provided in the middle part with half shells configured as semicircular embossings which form the distribution line, which can in turn be provided with inlet openings on the underside for the cooling liquid to enter the battery module.

To reduce installation space requirements and costs, it is also possible to use the usually already existing insulation cover, which is made of punched and molded plastic foils using so-called blister technology, is placed directly on the cells and prevents short circuits between the voltage- or potential-carrying cell housings and the cell connectors, to distribute the cooling liquid. For this purpose, a distribution line can be formed by a semicircular blister part, which is closed on the rear side, as the upper part, which is applied to the flat lower part of the insulation cover by thermal welding, and into the open end of which a connecting piece for supplying the cooling liquid can be inserted.

The cooling liquid is then discharged through inlet openings provided in the underside of the insulation cover in the region of the distribution line.

According to one advantageous configuration of the battery module, the fluid supply device can be disposed on one of the end faces between oppositely disposed electrical connecting elements of a battery cell, in particular centrally between them. Alternatively or additionally, the fluid supply device can comprise the distribution line having inlet openings, wherein the inlet openings are disposed distributed over the battery cells in the stacking direction. In such an embodiment, connecting elements which are disposed opposite to one another in a longitudinal extension of the battery cell can be supplied with cooling liquid from the distribution line disposed between them, so that particularly effective cooling is ensured.

According to one advantageous configuration of the battery module, the fluid supply device can be disposed on the module casing near one of the end faces. Alternatively or additionally, the fluid supply device can comprise the distribution line having inlet openings, wherein the inlet openings are disposed distributed over the number battery cells in the stacking direction. It is also advantageous to spray the heavily thermally loaded connecting elements of the battery cells with cooling liquid from the side through distribution lines integrated in connecting plates as side parts of the module casing.

After cooling the upper sides of the cells, through suitable sealing of the upper side of the cell packet, the cooling liquid then flows down via channels disposed in the end plates of the battery module.

According to one advantageous configuration of the battery module, the fluid supply device can be disposed on the module casing on the first end faces at the height of the electrical connecting elements. Alternatively or additionally, the fluid supply device can comprise the distribution line having inlet openings, wherein the inlet openings are disposed distributed in the stacking direction of the battery cells.

The connecting elements can in particular serve as a baffle element when cooling liquid is being supplied. The cooling liquid can in particular be directed onto the connecting elements from the side. The connecting elements of the battery cells can thus be supplied with cooling liquid and cooled particularly effectively.

According to a further aspect of the invention, a battery comprising at least one directly cooled battery module and comprising a battery housing having a fluid-tight lower part of the housing is proposed, wherein the battery housing comprises a fluid inlet and at least one fluid outlet for cooling liquid. The fluid inlet is fluidically connected to a fluid supply device of the at least one battery module. The battery housing comprises at least one collecting chamber for collecting the cooling liquid that has freely escaped from the at least one battery module.

Whereas the cooling liquid in batteries with direct cooling according to the known state of the art is conducted to and away from each individual battery module through corresponding line systems, in the embodiment according to the invention, the return lines are omitted, because the cooling liquid escapes from the battery modules into the lower part of the battery housing, where it is collected or suctioned off and can be returned to the cooling circuit.

The electrically non-conductive cooling liquid is fed to the battery module via lines, distributed in the battery module and then allowed to escape freely to the outside via outlet openings in the module casing or the cell packets of the battery modules. The coolant escaping from the battery modules into the battery housing can then be collected or suctioned off there and fed back into the coolant circuit.

With such a battery module, only the battery housing itself has to be sealed, which is usually already implemented in this way to shield the battery modules from environmental effects. The plurality of battery modules, on the other hand, do not have to be sealed, which reduces the costs, the weight and the installation space requirements for the battery according to the invention.

According to one advantageous configuration of the battery, the lower part of the housing can comprise integrated fluid channels, in particular suction channels, for discharging the cooling liquid, wherein the fluid channels are fluidically connected to the collecting chamber via openings. Channels which are integrated in the lower part of the housing, for example made of extruded parts, and into which the cooling liquid enters via openings distributed in the entire surface of the lower part of the housing make it possible to implement a particularly effective and installation space-saving recirculation of the cooling liquid.

According to one advantageous configuration of the battery, the battery housing can comprise fluid conducting elements disposed along a vertical axis. With fluid conducting elements additionally disposed on the housing base, the cooling liquid can be directed in a targeted manner to the collection openings or suction openings and sloshing of the cooling liquid when the vehicle accelerates or tilts can be prevented.

According to one advantageous configuration of the battery, filling bodies can be disposed in the interior of the battery housing between adjacent battery modules. The quantity of cooling liquid in the interior of the lower part of the battery housing can be reduced by filling bodies placed into the cavities, for example in the form of closed cell foams, plastic hollow bodies, and the like. The filling bodies can be formed from parts of the battery housing or battery modules.

According to one advantageous configuration of the battery, the fluid inlet and the fluid outlet can be connected via a closed fluid circuit comprising at least one of a cooling device, a heat exchanger, an air separator. In particular when the cooling liquid is actively being suctioned out of the lower part of the battery housing, which reduces the quantity of cooling liquid in circulation, an air separator, which operates according to the centrifugal principle, the air pot principle or the labyrinth principle, for example, can be disposed in the cooling liquid circuit upstream of the pump.

According to one advantageous configuration of the battery, a battery electronics unit, in particular at least one battery management system and/or switching components, can be integrated in the battery housing. The battery electronics (BMS and CSEs, contactors, ammeters, fuses and the like) can preferably be installed entirely inside the lower part of the housing which is configured as a sealed trough, so that only a few control lines, for example with a data bus system, have to be routed through the battery housing wall in a sealed manner.

According to one advantageous configuration of the battery, the battery housing can comprise a module casing of the at least one battery module. The lower part of the housing part can be configured as a collecting chamber for the cooling liquid that has freely escaped from the battery module, wherein a housing base of the lower part of the housing comprises openings for the cooling liquid to enter the collecting chamber.

The battery cells can optionally also be installed directly in the battery housing as a cell packet according to the so-called “cell-to-batt” design. The battery housing can thus comprise the module casing or itself be configured as a module casing. The cooling liquid can be distributed in the cell packet by means of suitable devices, for example by spraying the upper side of the battery cells from the distribution line. After flowing around the battery cells, the cooling liquid escapes from the cell packet into the lower part of the battery housing, where it is suctioned off as described above and returned to the cooling circuit.

The proposed solution can be implemented in batteries comprising known types of battery cells, such as pouch cells, prismatic hard-case cells or round cells.

According to one advantageous configuration of the battery, the lower part of the housing can comprise fluid channels for discharging the cooling liquid. After flowing around the battery cells, the cooling liquid can escape from the cell packet into the lower part of the battery housing, where it is suctioned off through the fluid channels as described above and returned to the cooling circuit.

### BRIEF DESCRIPTION OF THE DRAWINGS

Further advantages will emerge from the following description of the drawing. The figures show design examples of the invention. The figures, description and claims contain numerous features in combination. The person skilled in the art will expediently also consider the features individually and combine them into meaningful further combinations.

FIG. 1 an isometric illustration of a side element of a module casing comprising a distribution line in exploded view according to a design example of the invention;

FIG. 2 an isometric view of a battery module with side elements of the module casing comprising a distribution line of FIG. 1 with end plates of the module casing disposed on both sides of the battery cells;

FIG. 3 a cross-section through the battery module of FIG. 2;

FIG. 4 a longitudinal section through the battery module of FIG. 2;

FIG. 5 an enlarged detail of the longitudinal section of FIG. 4;

FIG. 6 a longitudinal section through a battery module according to a further design example of the invention with fluid channels in end plates on both sides of the battery cells of the battery module in which cooling liquid flows over and under the cells;

FIG. 7 an isometric plan view onto the battery module in its module casing of FIG. 6;

FIG. 8 an isometric view from below onto the module casing of FIG. 7;

FIG. 9 a schematic illustration of a battery module according to a design example of the invention comprising a fluid supply device on a first end face of the battery cells and outlet openings for the cooling liquid on an underside of a module casing with the side element of the module casing removed;

FIG. 10 a schematic illustration of a battery module according to a further design example of the invention comprising a fluid supply device on a second end face of the battery cells and outlet openings for the cooling liquid on an upper side of the module casing with the side element of the module casing removed;

FIG. 11 a schematic illustration of a battery module according to a further design example of the invention comprising a fluid supply device on a second end face of the battery cells and outlet openings disposed laterally in the module casing at a height of a vertical axis between the first and second end faces of the battery cells in the cell packet with the side element of the module casing removed;

FIG. 12 a side view of the battery module of FIG. 11;

FIG. 13 a schematic illustration of a battery module according to a further design example of the invention comprising a fluid supply device on a first end face of the battery cells and outlet openings disposed laterally in the module casing at a height of a vertical axis between the first and second end faces of the battery cells in the cell packet with the side element of the module casing removed;

FIG. 14 a schematic illustration of a battery module according to a further design example of the invention comprising a fluid supply device on a second end face of the battery cells and outlet openings disposed laterally in the module casing in the region of openings for passages of electrical leads with the side element of the module casing removed;

FIG. 15 a schematic illustration of a battery module according to a further design example of the invention comprising a fluid supply device on an underside of the battery module and outlet openings for the cooling liquid on an upper side of the module casing with the side element of the module casing removed;

FIG. 16 a schematic illustration of a battery module according to a further design example of the invention comprising a fluid supply device on a second end face of the battery cells and outlet openings for the cooling liquid on an upper side of the module casing, wherein filling bodies are disposed in the region of the fluid discharge with the side element of the module casing removed;

FIG. 17 the battery module of FIG. 10 with a schematic indication of venting gas escaping through the outlet openings of a venting battery cell;

FIG. 18 a schematic illustration of a battery according to a design example of the invention with four battery modules comprising outlet openings for cooling liquid which is collected in a lower part of the battery housing and discharged through a fluid outlet with the side wall of the battery housing removed;

FIG. 19 the battery of FIG. 18 comprising two fluid outlets with the side wall of the battery housing removed;

FIG. 20 a schematic illustration of a battery according to a further design example of the invention with battery modules comprising outlet openings for cooling liquid, which enters and is discharged through the fluid channels integrated in the lower part of the housing via openings distributed in the surface of the lower part of the housing with the side wall of the battery housing removed;

FIG. 21 a schematic illustration of a battery according to a further design example of the invention, wherein additionally disposed fluid conducting elements direct the cooling liquid to the openings of the fluid channels integrated in the lower part of the housing part and prevent sloshing of the cooling liquid with the side wall of the battery housing removed;

FIG. 22 a schematic illustration of a battery according to a further design example of the invention, wherein additionally disposed filling bodies reduce the quantity of cooling liquid in the lower part of the housing with the side wall of the battery housing removed;

FIG. 23 a schematic illustration of a battery according to a further design example of the invention with a closed fluid circuit with the side wall of the battery housing removed;

FIG. 24 a schematic illustration of a battery according to a further design example of the invention comprising an integrated battery electronics unit with the side wall of the battery housing removed;

FIG. 25 a schematic illustration of a battery according to a further design example of the invention comprising battery cells of a cell packet installed directly in the battery housing with the side wall of the battery housing removed;

FIG. 26 an exploded view of a battery module according to a design example of the invention comprising a channel structure disposed between the battery cells;

FIG. 27 an exploded view of a battery module according to a further design example of the invention comprising an adhesive mat disposed between the battery cells;

FIG. 28 an exploded view of a battery module according to a further design example of the invention with a channel structure comprising blind channels disposed between the battery cells;

FIG. 29 an isometric view of a battery module according to a further design example of the invention when a cooling liquid distribution line is being attached;

FIG. 30 the battery module of FIG. 29 with the distribution line attached;

FIG. 31 a longitudinal section through the battery module of FIG. 30;

FIG. 32 an enlarged detail of the longitudinal section of FIG. 31;

FIG. 33 a cross-section through the battery module of FIG. 30 in the region of the channel structure;

FIG. 34 an isometric illustration of a cover comprising a distribution line in exploded view;

FIG. 35 an isometric view of a battery module according to a further design example of the invention when the cover comprising the distribution line of FIG. 34 is being attached;

FIG. 36 the battery module of FIG. 35 with the cover comprising the distribution line attached;

FIG. 37 a longitudinal section through the battery module of FIG. 36;

FIG. 38 a cross-section through the battery module of FIG. 36 in the region of the channel structure;

FIG. 39 an isometric illustration of a cell connector unit comprising a distribution line in exploded view;

FIG. 40 an isometric view of a battery module according to a further design example of the invention when the cell connector unit comprising the distribution line of FIG. 39 is being attached;

FIG. 41 the battery module of FIG. 40 with the cell connector unit comprising the distribution line attached;

FIG. 42 a longitudinal section through the battery module of FIG. 41; and

FIG. 43 a cross-section through the battery module of FIG. 41 in the region of the channel structure.

### DETAILED DESCRIPTION OF THE INVENTION

In the figures, similar or similarly acting components are numbered with the same reference signs. The figures merely show examples and are not to be understood as limiting.

The directional terminology used in the following with terms such as “left”, “right”, “above”, “below”, “in front of”, “behind”, “after” and the like is merely intended to facilitate understanding of the figures and is in no way intended to represent a limitation of generality. The depicted components and elements, their design and use can vary according to the considerations of a person skilled in the art and can be adapted to the respective applications.

For the sake of clarity, reference signs of similar elements are only applied to one corresponding element in each figure.

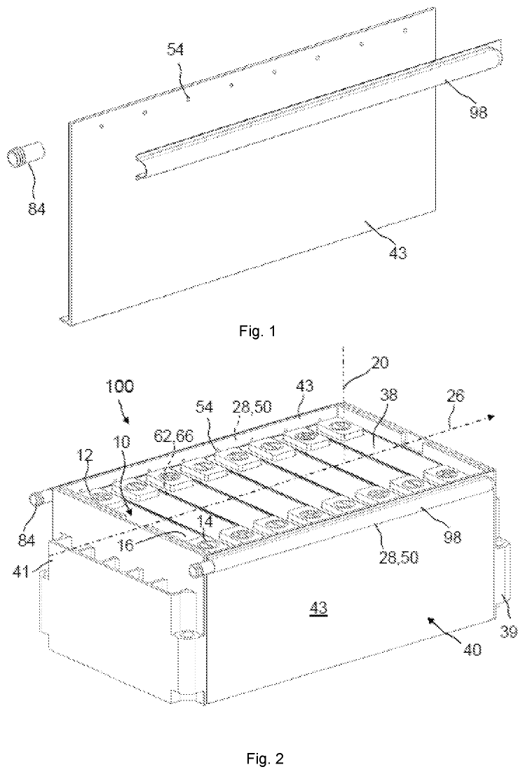

FIGS. 1 to 5 show a first design example of a battery module 100 according to the invention. The battery modules 100 are illustrated using so-called prismatic hard-case cells 10.

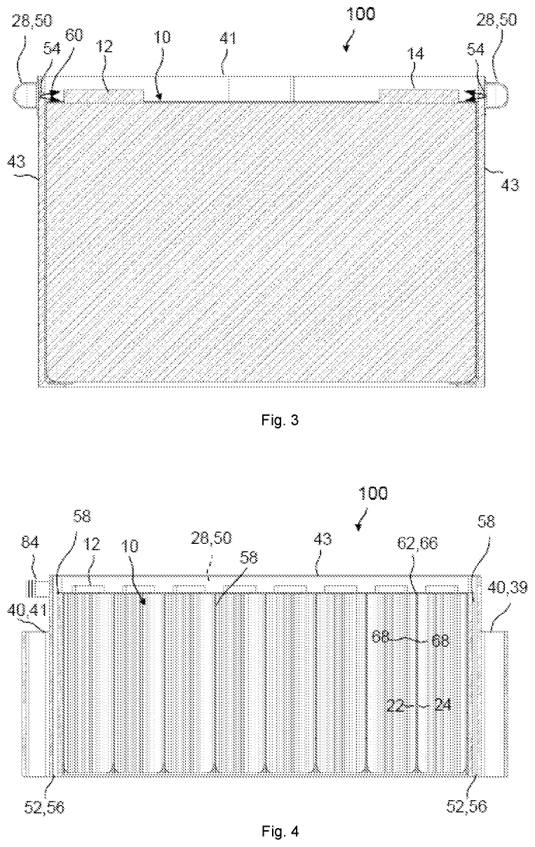

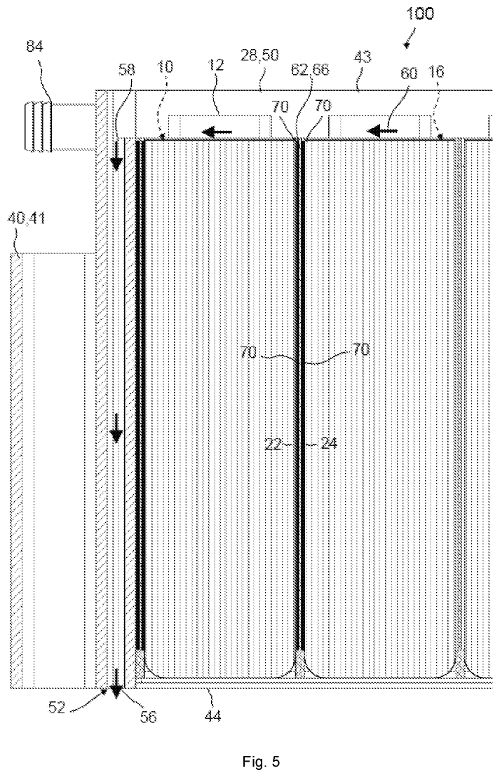

FIG. 1 shows an isometric illustration of a side element 43 of a module casing 40 with a distribution line 28 configured as an attachment 98 comprising a connecting piece 84 in an exploded view according to a design example of the invention, while FIG. 2 shows an isometric view of a battery module 100 with the side elements 43 of the module casing 40 comprising the distribution lines 28 of FIG. 1 with end plates 39, 41 of the module casing 40 disposed on both sides of the cell packet 38. FIG. 3 shows a cross-section through the battery module 100 of FIG. 2, while FIG. 4 shows a longitudinal section through the battery module 100. FIG. 5 shows an enlarged detail of the longitudinal section of FIG. 4.

The battery module 100 comprises a plurality of battery cells 10 disposed inside the module casing 40, wherein the module casing 40 encloses the plurality of battery cells at least in some regions. The battery cells 10 comprise a vertical axis 20 and first and second end faces 16, 18 which are spaced apart from one another in the direction of the vertical axis 20. The battery cells 10 are disposed successively in the form of a cell packet 38 in a stacking direction 26 transverse to the vertical axis 20.

On the first end face 16, the battery cells 10 each comprise two electrical connecting elements 12, 14 each of which forms a positive pole or negative pole and are connected in series via cell connectors 30. For the sake of clarity, the cell connectors 30 are not shown in the illustrations in FIGS. 2 to 5.

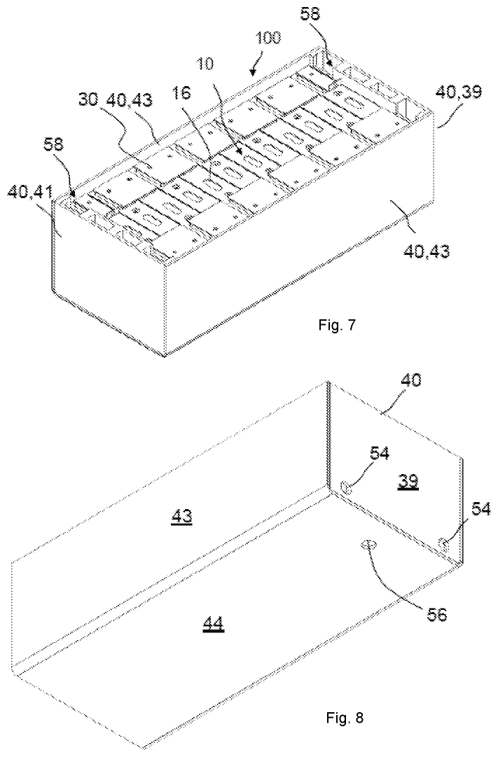

The cell connectors 30 are shown in the further design example in FIG. 7, however, and would also be similarly installed in the design example shown in FIGS. 1 to 5. Not depicted current feeds to the free connecting elements 12, 14 of the edge cells are led out of the module casing 40 at the ends of the cell packet 38. The cell voltages are respectively tapped at the connecting elements 12, 14 via separate electrical leads (not shown) and led separately out of the module casing 40.

The directly cooled battery module 100 comprises a fluid supply device 50 having two distribution lines 28 comprising a plurality of inlet openings 54, which, in intended operation, directs a cooling liquid 60 onto the battery cells 10, in particular sprays said cooling liquid onto the connecting elements 12, 14 of the battery cells 10, and can thus advantageously dissipate the heat at the point of origin in the battery cell 10. The battery module 100 further comprises one or more outlet openings 56 for freely discharging the cooling liquid 60 from the module casing 40 and the cell packet 38 into the surroundings of the module casing 40. The cooling liquid 60 escaping from the battery modules 100 into a not depicted battery housing can then be collected or suctioned off there and fed back into a coolant circuit.

The passages to the electrical leads therefore do not have to be sealed. There is in particular no longer a need to seal the module casing 40 on all sides. Only the battery housing has to be sealed in order to collect the cooling liquid 60. A level-controlled tank or reservoir for cooling liquid 60 can be omitted. This function is carried out by the lower part of the battery housing.

The flow of cooling liquid 60 through the battery modules 100 and through the batteries 200 constructed with them is respectively indicated in the figures by means of arrows.

The module casing 40 is configured as a wall which extends around the vertical axis 20 of the cell packet 38 and can in particular be configured as a band or frame.

The module casing 40 comprises a (not depicted) upper side 42 and an underside 44. In the design example in FIGS. 1 to 5, the outlet openings 56 are disposed on the underside 44. In this design example, a fluid discharge 52 is thus disposed on the underside 44 of the module casing 40.

The inlet openings 54 for the cooling liquid 60 are disposed directed toward the first end faces 16 such that the cooling liquid 60 escapes from the inlet openings 54 onto the first end faces 16 and can thus preferably cool the first end faces 16 and the connecting elements 12, 14 disposed there. The outlet openings 56 for discharging the cooling liquid 60 are disposed on the opposite side of the cell packet 38 with respect to the vertical axis 20.

This variant results in a particularly low weight, because the cooling liquid 60, which is sprayed onto the battery cells 10 from above, runs down in the end plates 39, 41 and escapes at the underside 44 of the module casing 40 without collecting in the interior of the module. There is also no need for additional piping in the battery module 100 for conducting the cooling liquid 60.

The fluid supply device 50 preferably comprises at least one inlet opening 54 per electrical connecting element 12, 14 of the battery cells 10 and is thus advantageously configured for targeted distribution of the cooling liquid 60 over the first end face 16 of the battery cells 10 in the cell packet 38. The fluid supply device 50 can thus in particular distribute the cooling liquid 60 over the electrical connecting elements 12, 14 of the battery cells 10 in the cell packet 38 in a targeted manner.

The distribution line 28 is formed in the side element 43 in that the side element 43 comprises inlet openings 54 distributed in the stacking direction 26 of the cell packet 38 and a semicircular attachment 98, which forms a channel of the distribution line 28, is disposed on the side element 43 from an outer side of the module casing 40 over the inlet openings 54. The cooling liquid 60 is fed to the distribution line via a connecting piece 84.

The admission of the cooling liquid 60 through the inlet openings 54 can take place via bores in the side elements 43 (in the case of spraying) as well as via elongated holes (in the case of an inflow). In the case of an inflow, turbulence occurs in the inlet around the connecting elements 12, 14, as a result of which ideal heat transfer at the first end face 16 of the battery cell 10 is achieved. In this design example, the inflow is from both sides, the stagnation point is in the middle and the outflow takes place via an integrated outflow channel 58 in the two end plates 39, 41 back into a liquid trough.

This makes it possible to significantly increase the heat dissipation from the battery cells 10 via the connecting elements 12, 14. A temperature difference across the height of the battery cell 10 can thus be significantly lower than in the current state of the art, for example with a value less than 15 K instead of as previously greater than 20 K.

The fluid supply device 50 is disposed on the module casing 40 on the first end faces 16 at the height of the electrical connecting elements 12, 14. When the cooling liquid 60 is being supplied, said liquid can flow against the connecting elements 12, 14 or they can be sprayed from the side. The connecting elements serve as a baffle element for the cooling liquid and thus contribute to an even distribution of the cooling liquid 60 around the connecting elements 12, 14 and onto the first end face 16 of the cell packet 38.

In the cross-section in FIG. 3, it is particularly easy to see how the connecting elements 12, 14 of the battery cells 10 are sprayed with cooling liquid 60 or how cooling liquid flows against them.

In the longitudinal section, in particular in the enlarged detail in FIG. 5, it can be seen how the cooling liquid 60 can be distributed over the first end face 16 of the cell packet 38 and flow off via respective channels 58, which, in this design example, are configured in the end plates 39, 41. The cooling liquid 60 can freely escape through the outlet openings 56 at the lower end of the fluid channels 58, on the underside 44 of the module casing 40.

The channel structure 66 of the liquid-permeable layer 62 between the battery cells 10 in this design example is configured with blind channels 70. The cooling liquid 60 substantially stands in the blind channels 70 and, if at all, is distributed by convection.

The design example in FIGS. 1 to 5 can be further simplified in that there is only a lateral fluid supply device 50 and the outflow of the cooling liquid 60, again integrated in the end plates 39, 41 as a fluid channel 58, takes place at the end of flowing over the battery cells 100 from the battery module 100 into a lower part of the housing 212 configured as a base trough.

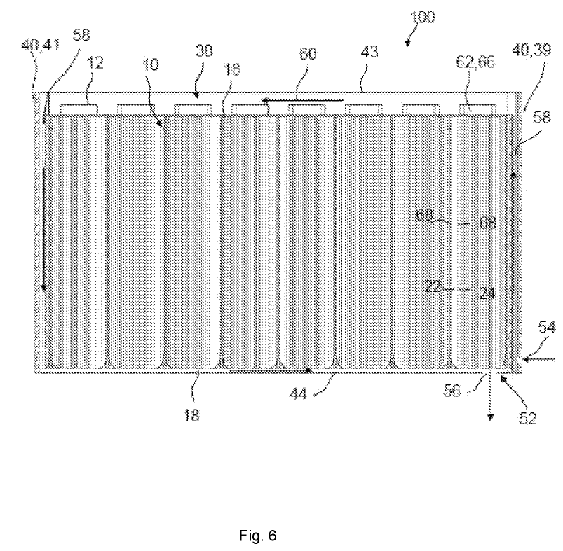

FIGS. 6 to 8 show a further design example of the invention. The battery modules 100 are illustrated using so-called prismatic hard-case cells 10.

In this design example, the cooling liquid 60 enters the one end plate 39 near the underside 44 of the module casing 40 through one or more inlet openings 54, in this example through two inlet openings 54, and flows upward toward the first, upper end face 16 of the cell packet 38. At the first end face 16, the cooling liquid 60 is distributed over the first end face 16 comprising the electrical connecting elements 12 and not depicted cell connectors. Since the heat loss occurs largely in the region of the connecting elements and is transferred to the cell connectors by thermal conduction, a particularly favorable heat dissipation can take place via an areal flow over the electrical connecting elements 12 on the first end face 16 without a fluid channel explicitly configured for this purpose.

In a further not depicted design example, a filling body, for example in the form of a blister, can advantageously be disposed in the region between the electrical connecting elements along the cell packet, so that the cooling liquid flows on both sides of the filling body substantially over the electrical connecting elements. If venting openings are disposed in the cell housings between the connecting elements, a filling body can still be disposed above them. For this purpose, the filling body can expediently comprise suitable recesses at the location of the venting openings, through which escaping gas can flow out. The filling body promotes suitable flow of the cooling liquid over the electrical connecting elements for the greatest possible dissipation of heat at the point of origin. The filling body also reduces the free volume in the battery module, so that a smaller volume of cooling liquid is needed.

The cooling liquid 60 then flows out through the fluid channel 58 in the opposite end plate 41 to the underside 44 of the module casing 40. On the underside 44, the cooling liquid 60 freely escapes into the surroundings of the battery module 100 through one or more outlet openings 56, in this example through an outlet opening 56. It can be advantageous if the outlet opening 56 disposed near the end plate 41 comprising the at least one inlet opening 54.

In a further not depicted design example, the inlet openings 54 into the end plate 39 can optionally be disposed from the underside of the end plate 39 and/or from the underside 44 of the module casing 40. The supply and discharge of the cooling liquid 60 to the battery module 100 can thus be configured in a particularly favorable manner.

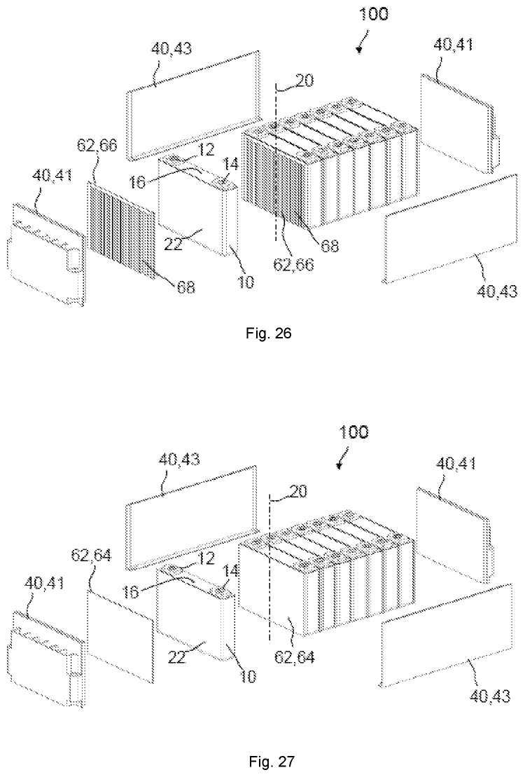

A design example that is further improved compared to the design examples shown in FIGS. 1 to 8 can comprise a porous foam mat or a rubber-like press mat having channels 68 disposed between the battery cells 10 as a liquid-permeable layer 62 (as in the design examples shown in FIGS. 26 and 27) that fills with cooling liquid 60 when the battery is put into operation.

In the event of thermal propagation of the battery 200, this provides an additional advantage: After an exothermic reaction in a battery cell 10 in the battery module 100 involving venting of the produced electrolyte gas on the first end face 16 directly into the cooling liquid 60, evaporative cooling occurs between the defective battery cell 10 and the two neighboring cells 10, and also the first end face 16 exposed to coolant of the defective battery cell.

This makes it possible to prevent an unwelcome sharp rise in the temperature in the two neighboring cells 10 of the defective battery cell 10. Thermal propagation in the battery module 100 and the battery 200 as a whole can advantageously be prevented.

The electrolyte gas can moreover combine with a portion of the vaporized cooling liquid 60 and be safely discharged into the battery 200 via a venting mechanism outside the battery module 100.

A gas mixture created when electrolyte gas and cooling liquid 60 are combined is typically far less combustible than the pure electrolyte gas. Direct ignition above the battery cells 10 can thus also be prevented by the cooling liquid 60. Sparking, which causes the electrolyte gas to ignite, can be prevented as well. The cooling liquid 60 can extinguish the defective ignited battery cell 10. The harmful process can thus stop.

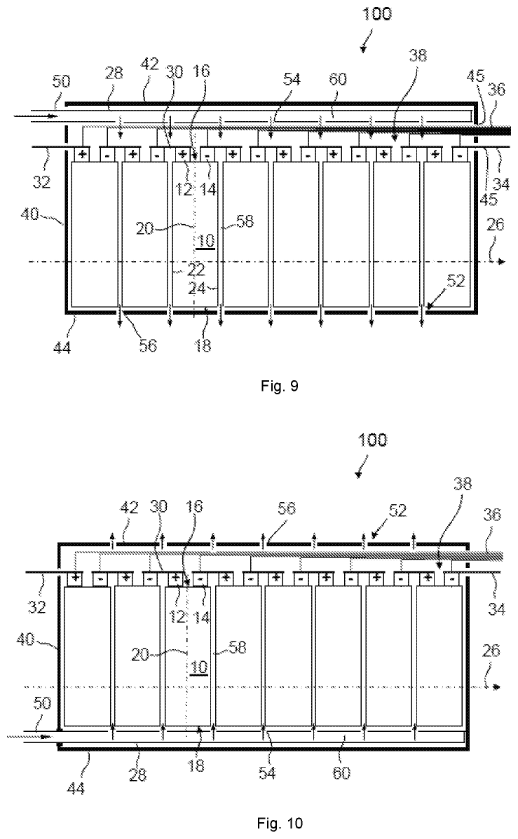

FIGS. 9 to 17 show different embodiments of battery modules 100 in a module casing 40. For the sake of visibility, the side element of the module casing 40 facing the viewer is removed in FIGS. 9 to 11 and 13 to 17.

FIGS. 9 to 17 and 18 to 24 further show embodiments of module casings 40 or battery modules 100 with module casings 40 which comprise end plates 39, 41, side elements 43 and also an underside 44 and an upper side 42. However, this is intended to represent only one possible embodiment of a module casing 40. A battery module 100 can alternatively also be configured with only a frame which encloses the battery cells 10 and consists of end plates 39, 41 and side elements 43 as a module casing 40 without an underside 44 and/or without an upper side 42. Instead of an enclosing frame, it is optionally also possible to use a tensioning belt.

FIG. 9 shows a schematic illustration of a battery module 100 according to a design example of the invention comprising a fluid supply device 50 on a first end face 16 of the battery cells 10 and outlet openings 54 for the cooling liquid 60 on an underside 44 of a module casing 40.

The battery module 100 comprises a plurality of battery cells 10 disposed inside the module casing 40, wherein the module casing 40 encloses the plurality of battery cells at least in some regions. The battery cells 10 comprise a vertical axis 20 and first and second end faces 16, 18 which are spaced apart from one another in the direction of the vertical axis 20. The battery cells 10 are disposed successively in the form of a cell packet 38 in a stacking direction 26 transverse to the vertical axis 20.

The battery cells 10 each comprise two electrical connecting elements 12, 14, which are marked “+” and “—” and are connected in series via cell connectors 30. Two current feeds 32, 34 to the free connecting elements 12, 14 of the edge cells are led out of the module casing 40 at the ends of the cell packet 38.

The cell voltages are respectively tapped at the connecting elements 12, 14 via separate electrical leads 36 and led separately out of the module casing 40.

The directly cooled battery module 100 comprises a fluid supply device 50 having one distribution line 28 comprising a plurality of inlet openings 54, which, in intended operation, directs a cooling liquid 60 onto the battery cells 10, in particular sprays said cooling liquid onto the connecting elements 12, 14 of the battery cells 10, and can thus advantageously dissipate the heat at the point of origin in the battery cell 10.

The battery module 100 further comprises a plurality of outlet openings 56 for freely discharging the cooling liquid 60 from the module casing 40 and the cell packet 38. The cooling liquid 60 escaping from the battery modules 100 into a battery housing can then be collected or suctioned off there and fed back into a coolant circuit.

The passages 45 to the electrical leads 32, 34, 36 therefore do not have to be sealed.

There is in particular no longer a need to seal the module casing 40 on all sides. Only the battery housing has to be sealed in order to collect the cooling liquid 60. A level-controlled tank or reservoir for cooling liquid 60 can be omitted. This function is carried out by the lower part of the battery housing.

The flow of cooling liquid 60 through the battery modules 100 and through the batteries 200 constructed with them is indicated in this and the following figures by means of arrows.

The module casing 40 is configured as a wall which extends around the vertical axis 20 of the cell packet 38 and can in particular be configured as a band or frame.

The module casing 40 comprises an upper side 42 and an underside 44. In the design example in FIG. 9, the outlet openings 56 are disposed on the underside 44. In this design example, the fluid discharge 52 is thus disposed on the underside 44 of the module casing 40.

The inlet openings 54 for the cooling liquid 60 are disposed directed toward the first end faces 16 such that the cooling liquid 60 escapes from the inlet openings 54 onto the first end faces 16 and can thus preferably cool the first end faces 16 and the connecting elements 12, 14 disposed there. The outlet openings 56 for discharging the cooling liquid 60 are disposed on the opposite side of the cell packet 38 with respect to the vertical axis 20.

This variant results in a particularly low weight, because the cooling liquid 60, which is sprayed onto the battery cells 10 from above, runs down said battery cells and escapes at the bottom without collecting in the interior of the module.

The fluid supply device 50 preferably comprises at least one inlet opening 54 per electrical connecting element 12, 14 of the battery cells 10 and is thus advantageously configured for targeted distribution of the cooling liquid 60 over the first end face 16 of the battery cells 10 in the cell packet 38. The fluid supply device 50 can thus in particular distribute the cooling liquid 60 over the electrical connecting elements 12, 14 of the battery cells 10 in the cell packet 38 in a targeted manner.

In another embodiment, the fluid supply device 50 can advantageously comprise a nozzle assembly that sprays the cooling liquid 60 onto the cell packet 38.

This makes it possible to achieve a better cooling effect of the cooling liquid 60, in particular at the point of origin of the heat, namely the electrical connecting elements 12, 14 of the battery cells 10.

Inside the module casing 40, fluid channels 58 are respectively disposed between the battery cells 10 along the side walls 22, 24 of the battery cells 10 between the first end face 16 and the second end face 18 of the battery cells 10 in the cell packet 38, so that the supplied cooling liquid 60 can pass from the inlet openings 54 over the connecting elements 12, 14 of the battery cells 10 via the fluid channels 58 to the outlet openings 56 of the module casing 40.

FIG. 10 shows a schematic illustration of a battery module 100 according to a further design example of the invention comprising a fluid supply device 50 on the second end face 18 of the battery cells 10 and outlet openings 54 for the cooling liquid 60 on the upper side 42 of the module casing 40.

The inlet openings 54 are directed toward the second end faces 18 in a targeted manner such that the cooling liquid 60 from the inlet openings 54 hits the second end faces 18, while the outlet openings 56 are disposed on the opposite side of the cell packet 38 with respect to the vertical axis 20. The cooling liquid 60 that has entered thus rises upward in the fluid channels 58 between the battery cells 10 and escapes from the battery module 100 on the upper side 42 of the module casing 40.

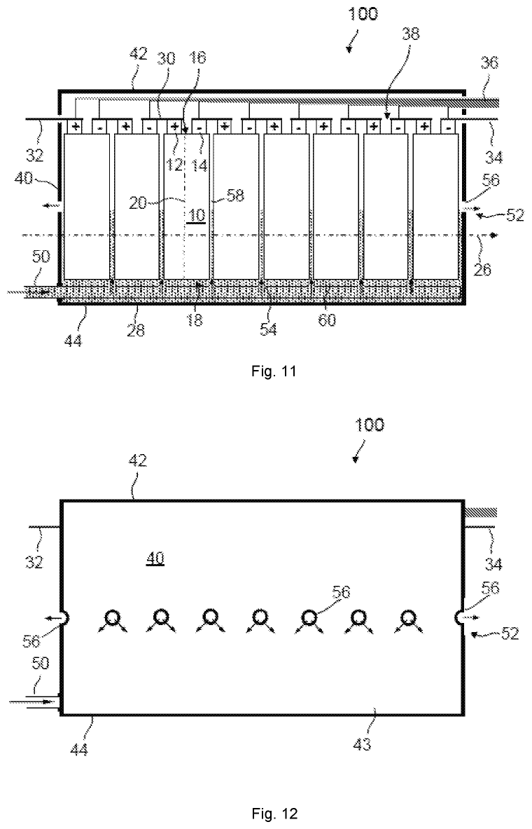

FIG. 11 shows a schematic illustration of a battery module 100 according to a further design example of the invention comprising a fluid supply device 50 which is disposed with respect to the vertical axis 20 on the side of the cell packet 38 comprising the second end faces 18.

The outlet openings 56 are disposed laterally in the module casing 40 at a height of a vertical axis 20 between the first and second end faces 16, 18 of the battery cells 10 in the cell packet 38. For this purpose, FIG. 12 shows a side view of the battery module 100 in which the outlet openings 56 can be seen.

To ensure even cooling liquid distribution, the outlet openings 56 are preferably distributed over the periphery of the module casing 40. The cooling liquid 60, shown dotted in FIG. 11, rises to a fluid level that corresponds to the height of the outlet openings 56 and then flows into the surroundings of the battery module 100 via the outlet openings 56 of the fluid discharge 52.

The cooling liquid 60 in the interior of the battery module 100 below the outlet openings 56 can be used specifically as a thermal buffer in the event of a brief increase in heat generation of the battery cells 10 during power peaks, for example during vehicle acceleration.

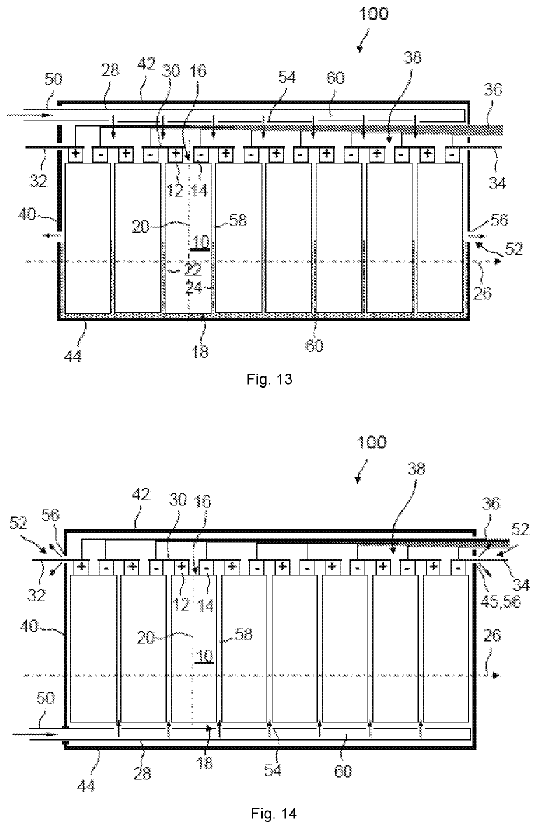

FIG. 13 shows a schematic illustration of a battery module 100 according to a further design example of the invention comprising a fluid supply device 50 which is disposed with respect to the vertical axis 20 on the side of the cell packet 38 comprising the first end faces 16. As in the design example of FIGS. 11 and 12, the outlet openings 56 are disposed laterally in the module casing 40 at a height of the vertical axis 20 between the first and second end faces 16, 18 of the battery cells 10 in the cell packet 38.

This design example therefore differs from the design example in FIGS. 11 and 12 in that the supply of the cooling liquid 60 takes place from above via the connecting elements 12, 14 of the battery cells 10. Here too, the fluid level in the battery module 100 permanently reaches the height of the outlet openings 56, since only in this way is it possible for the cooling liquid 60 to flow off.

FIG. 14 shows a schematic illustration of a battery module 100 according to a further design example of the invention comprising a fluid supply device 50 on the second end face 18 of the battery cells 10 and outlet openings 56 disposed laterally in the module casing 40 in the region of openings for passages 45 of electrical leads 36. The supplied cooling liquid 60 rises in the fluid channels 58 between the battery cells 10 until it reaches the height of the passages 45 of the current feeds 32, 34 and escapes in a defined manner into the surroundings via the passages 45. As a result, the module casing 40 advantageously does not have to be sealed.

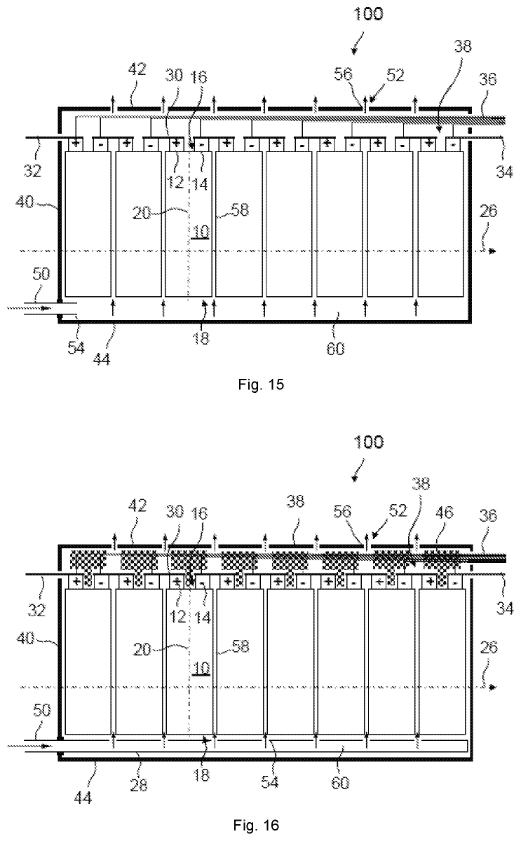

FIG. 15 shows a schematic illustration of a battery module 100 according to a further design example of the invention comprising a fluid supply device 50 on the underside 44 of the battery module 100 and outlet openings 56 for the cooling liquid 60 on the upper side 42 of the module casing 40.

The module casing 40 comprises a wall which extends around the vertical axis 20 of the cell packet 38 and at least one at least largely closed upper side 42 on the side of the cell packet 38 comprising the first end faces 16. The fluid supply device 50, which is configured as a short socket without a distribution line, but preferably with a relatively large cross-section, is disposed on the side of the cell packet 38 comprising the second end faces 18. The outlet openings 56 are disposed in the upper side 42 of the module casing 40.

Alternatively, as in the design examples in FIGS. 11 to 13, the outlet openings 56 could be disposed at a height between the first and the second end faces 16, 18 of the cell packet 38.

The outlet openings 56 advantageously have a cross-section which is configured such that a higher pressure loss for the cooling liquid 60 occurs at the outlet openings 56 than at the inlet opening 54, which preferably has a relatively large cross-section. The outlet openings 56 can thus be configured as restriction openings. This makes it possible to achieve a defined escape of the cooling liquid 60 and an even distribution of the cooling liquid 60.

The outlet openings 56 in this design example can also be disposed halfway between the first and second end faces 16, 18 of the battery cells 10.

FIG. 16 shows a schematic illustration of a battery module 100 according to a further design example of the invention comprising a fluid supply device 50 on a second end face 18 of the battery cells 10 and outlet openings 56 for the cooling liquid 60 on an upper side 42 of the module casing 40, wherein filling bodies 46 are disposed in the interior of the module casing 40 in the region of the fluid discharge 52. The filling bodies 46, which can be made of hollow material, for example, reduce the quantity of cooling liquid in the interior of the module.

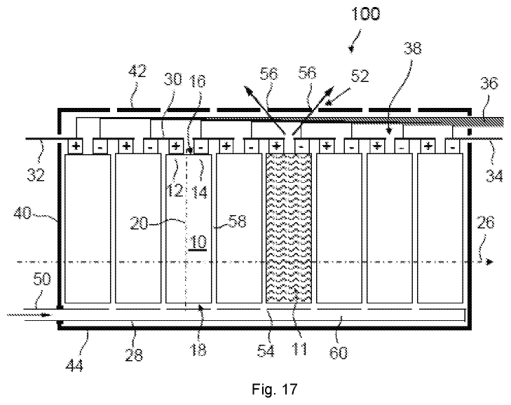

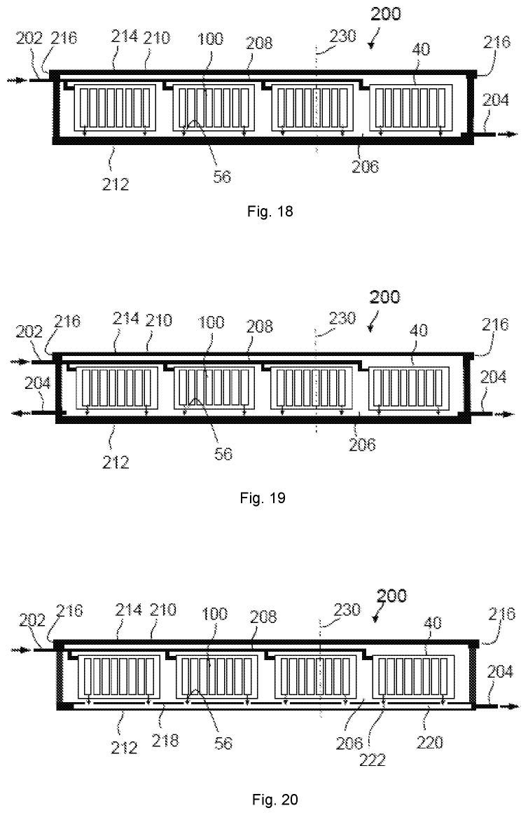

FIG. 17 shows a battery module 100 as shown in FIG. 10, with a schematic indication of venting gas escaping through the outlet openings 56 of a venting battery cell 10.

If an exothermic reaction of the cell chemistry occurs from the battery cell, for example as a result of overcharging or an internal short circuit, a larger volume of gas, so-called venting gas, can form, which can escape from the battery cell 10 via a so-called bursting membrane. This gas can combine with the cooling liquid 60 and escape from the module casing 40 through the outlet openings 56 for the cooling liquid 60 disposed in the immediate vicinity. This advantageously makes it possible to prevent the development of increased gas pressure in the battery module 100. Additional venting means, such as overpressure valves and diaphragms in the module casing 40 that open only in the event of overpressure, can thus be omitted. Battery housings in which such a battery module 100 is installed typically have dedicated venting openings through which the venting gas can be released into the surroundings.

FIGS. 18 to 25 show different embodiments of batteries 200 comprising a battery housing 210. For the sake of visibility, the side wall of the battery housing 210 facing the viewer is removed in the figures.

FIG. 18 shows a schematic illustration of a battery 200 according to a design example of the invention with four battery modules 100 comprising outlet openings 56 for cooling liquid 60 which is collected in a lower part of the battery housing 212 and discharged through a fluid outlet 204.

The battery 200 comprises a battery housing 210 having an upper part of the housing 214 and a fluid-tight lower part of the housing 212.

The lower part of the housing 212 can, for example, be configured as a trough, which is closed with a flat upper part of the housing 214 as a lid. The two housing parts 212, 214 can be connected in a sealed manner via a housing flange 216, for instance.

The battery housing 210 further comprises a fluid inlet 202 and at least one fluid outlet 204 for cooling liquid 60, wherein the fluid inlet 202 is fluidically connected to a fluid supply device 50 of the battery modules 100. The battery housing 210 comprises at least one collecting chamber 206 for collecting cooling liquid 60 that has freely escaped from the battery modules 100. The cooling liquid 60 can be suctioned off via the fluid outlet 204 and fed to a cooling circuit that is preferably configured such that it is closed.

Whereas the cooling liquid in batteries with direct cooling according to the known state of the art is conducted to and away from each individual battery module 100 through corresponding line systems, in the embodiment according to the invention, the return lines are omitted, because the cooling liquid 60 escapes from the battery modules 100 into the lower part of the battery housing 212, where it is collected or suctioned off and returned to the cooling circuit.

For this purpose, FIG. 19 shows such a battery 200 comprising two fluid outlets 204, so that the cooling liquid 60 can be discharged and/or suctioned off even when the vehicle is tilted or when transverse and/or longitudinal accelerations are occurring.

FIG. 20 shows a schematic illustration of a battery 200 according to a further design example of the invention with battery modules 100 comprising outlet openings 56 for cooling liquid 60, which enters and is discharged through the fluid channels 220 integrated in the lower part of the housing 212. via openings 222 distributed in the surface of the housing base 218 of the lower part of the housing 212. The housing base 218, which is made of extruded parts, for example, comprises integrated fluid channels 220, in particular suction channels for discharging the cooling liquid 60. The fluid channels 220 are fluidically connected to the collecting chamber 206 via openings 222 and can be distributed over the entire the surface of the housing base 218. The cooling liquid 60 can be suctioned off via the fluid channels 220, for example.

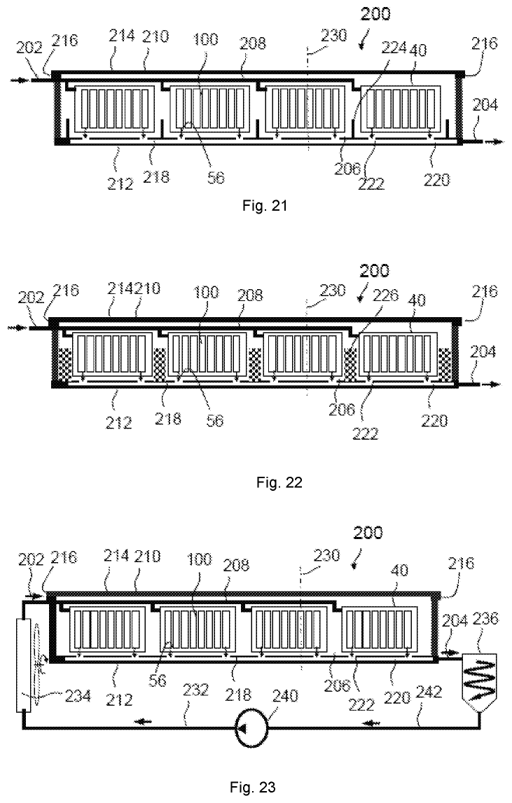

FIG. 21 shows a schematic illustration of a battery 200 according to a further design example of the invention, wherein additional fluid conducting elements 224 disposed along a vertical axis 230 direct the cooling liquid 60 to the openings 222 of the fluid channels 220 integrated in the lower part of the housing 212 and prevent sloshing of the cooling liquid 60. The cooling liquid 60 can thus be directed toward the openings 222 in a targeted manner. Sloshing of the cooling liquid 60 that has escaped into the lower part of the housing 212 due to acceleration of the vehicle can be effectively suppressed by the fluid conducting elements 224.

FIG. 22 shows a schematic illustration of a battery 200 according to a further design example of the invention, wherein additionally disposed filling bodies 226 reduce the quantity of cooling liquid in the lower part of the housing 212. The filling bodies 226, which can be made of hollow material, for example, reduce the free volume present in the battery housing 210 and thus also reduce the quantity of standing cooling liquid 60.

The filling bodies 226 can be formed from parts of the battery housing 210 or battery modules 100.

FIG. 23 shows a schematic illustration of a battery 200 according to a further design example of the invention with a closed fluid circuit 232. The fluid inlet 202 and the fluid outlet 204 are connected via a closed fluid circuit 232, which comprises at least one of a cooling device 234, a heat exchanger, an air separator 236.

The cooling liquid 60 is suctioned off via fluid channels 220 integrated in the lower part of the housing 212 and is fed to the closed fluid circuit 232 via the fluid outlet 204. Before the cooling liquid 60 reenters the fluid circuit 232 comprising a pump 240 and a cooling device 234, for example an ambient air cooler with a fan, or a heat exchanger operated with evaporating refrigerant of the vehicle air conditioning system, the air is removed in an air separator 236, for example according to the centrifugal principle, the air pot principle or the labyrinth principle. The battery housing 210 also serves to store the cooling liquid, so that an additional level-controlled tank or reservoir is not required.

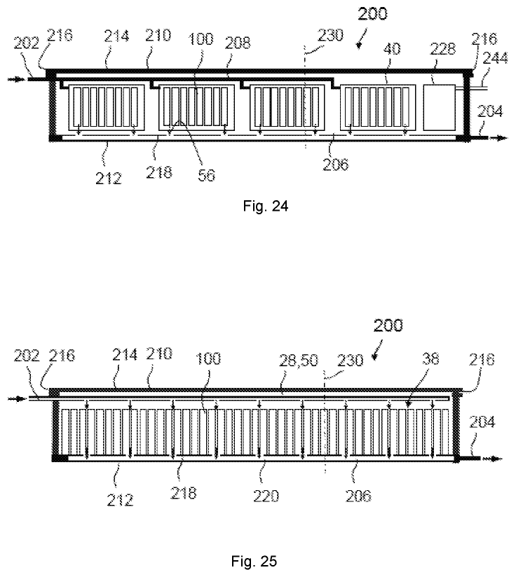

FIG. 24 shows a schematic illustration of a battery 200 according to a further design example of the invention comprising an integrated battery electronics unit 228. Peripherals of the battery electronics, such as the battery management system (BMS), the cell voltage monitoring (CSE), contactors, ammeters, fuses, can be disposed in the interior of the battery housing 210, so that only the current supply lines and current discharge lines and a few control lines 244 (for example as a data bus) have to be routed through the battery housing wall in a sealed manner.

The battery electronics unit 228, in particular at least one battery management system and/or switching components, can thus advantageously be integrated in the battery housing 210.

FIG. 25 shows a schematic illustration of a battery 200 according to a further design example of the invention comprising battery cells 10 of a cell packet 38 installed directly in the battery housing 210. The battery housing 210 comprises a module casing 40 of the at least one battery module 100. The lower part of the housing 212 is configured as a collecting chamber 206 for the cooling liquid 60 that has freely escaped from the battery module 100, wherein the lower part of the housing 212 comprises openings 222 for the cooling liquid 60 to enter the collecting chamber 206. Fluid channels 220 in the lower part of the housing 212 serve to discharge the cooling liquid 60.

The cells installed directly in the housing are sprayed from the first end face 16 of the battery cells 10 through a distribution line 28 with cooling liquid 60, which flows downward along and between the side walls 22, 24 of the battery cells 10 and then enters and is suctioned off through the fluid channels 220 integrated in the lower part of the housing 212 via openings 222 distributed in the surface of the housing base 218.

FIGS. 26 to 35 show further structural design examples of different battery modules 100 according to the invention comprising so-called prismatic hard-case cells 10. The battery modules 100 have a fundamentally similar structure.

The battery cells 10 are glued to one another and to the pressure plates disposed at the two ends of the cell packet 38 as end plates 39, 41, wherein adhesive mats or adhesive plates 62, which typically also serve to compensate length tolerances and to compensate changes in cell thickness over the state of charge or aging state, are disposed in the spaces between the battery cells 10. After the cell packet 38 has been pressed axially to the desired length, the end plates 39, 41 are connected to one another as side elements 43, for example via connecting plates welded to the side, to form the battery module 100. The electrical interconnection of the battery cells 10 and the supply and discharge of the current is accomplished by welded-on cell connectors 30. Means for measuring the cell voltage and for so-called balancing, charge equalization between the individual battery cells 10 and a cover of the battery module 100 disposed above the cell connectors 30 are not depicted.

The cooling liquid 60 can be supplied through a distribution line 28, for example, which can be provided with inlet openings 54 and disposed above the battery cells 10.

FIG. 26 shows an exploded view of a battery module 100 according to a design example of the invention comprising a channel structure 66 disposed between the battery cells 10.

The battery module 100 comprises eight prismatic hard-case cells 10, the connecting elements 12, 14 of which are disposed on the first end face 16 of the battery cells 10. Liquid-permeable layers 62 respectively configured as a channel structure 66 are disposed between the battery cells 10 and provided with channels 66 for guiding the cooling liquid 60 between the battery cells 10.

The layers 62 can be glued onto the side walls 22, 24 of battery cells 10, for example.

In this design example, the module casing 40 comprises two stable end plates 39, 41 on both end sides of the battery module 100 that can apply a contact pressure necessary for the operation of the battery cells 10 to the battery cells 10. The two end plates 39, 41 are connected via two opposite side elements 43 and can in particular be screwed or welded.

The channel structure 66 comprising channels 68 which extend from one end face 16 to the other end face 18 of the battery cells 10 in the cell packet 38 is disposed parallel to the vertical axis 20, wherein the channels 68 are configured such that they are continuous over a height of the battery cell 10.

FIG. 27 shows an exploded view of a battery module 100 according to a further design example of the invention comprising an adhesive mat 64 disposed between the battery cells 10.

In this design example, a liquid-permeable layer 62, in particular a porous adhesive mat 64, is disposed at least partly between the battery cells 10 in the direction of the vertical axis 20. The adhesive mat 64 can be made of porous material (open-pore foam mat, nonwoven fabric and the like), for instance, that soaks up cooling liquid which cools the side walls 22, 24 of the battery cells 10 and escapes freely at the underside 44. Due to its thermal capacity, the cooling liquid 60 can mitigate thermal load peaks and thus prevent thermal propagation in the cell packet 38, in particular after an exothermic reaction of a battery cell 10.

The adhesive mat 64, which is preferably self-adhesive, can be glued to the side walls 22, 24 of the battery cells 10.

The adhesive mat 64 is configured to have a suitable porosity that allows the cooling liquid 60 to seep between the cells, so that the adhesive mat 64 is soaked in intended operation with the cooling liquid 60.

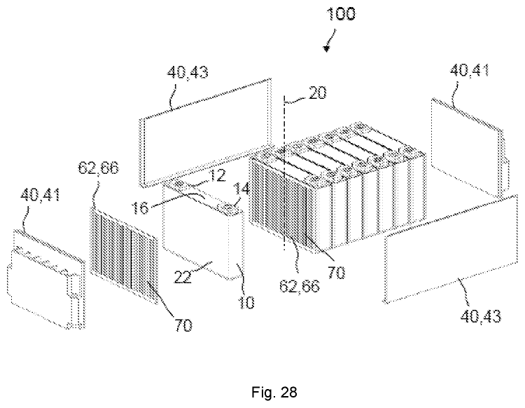

FIG. 28 shows an exploded view of a battery module 100 according to a further design example of the invention with a channel structure 66 comprising blind channels 70 disposed between the battery cells 10. In this design example, as in the design example in FIG. 26, liquid-permeable layers 62 in the form of a channel structure 66 are disposed between the battery cells 10, which in this case is provided with blind channels 70. The cooling liquid 60 is conducted between the battery cells 10 via the blind channels 70, since the blind channels 70 can fill with standing cooling liquid 60, which in turn can mitigate thermal load peaks and prevent thermal propagation in the cell packet 38.

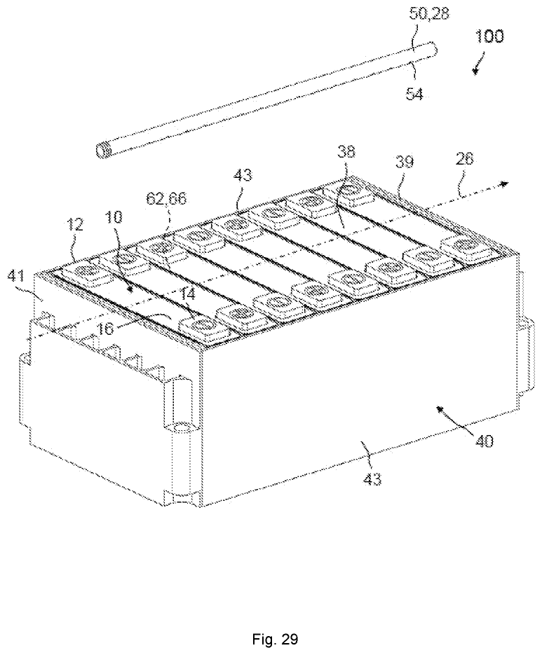

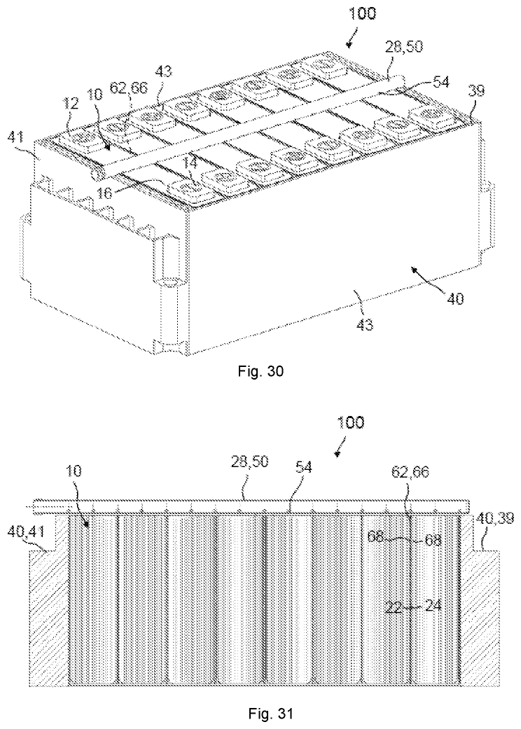

FIG. 29 shows an isometric view of a battery module 100 according to a further design example of the invention when a cooling liquid distribution line 28 is being attached. FIG. 30 shows the battery module 100 with the distribution line 28 centrally attached.

The distribution line 28 is disposed, in particular centrally, as the fluid supply device 50 on one of the end faces 16, 18 between oppositely disposed electrical connecting elements 12, 14 of a battery cell 10. On its side facing the first end face 16 of the battery cells 10, the distribution line 28 comprises inlet openings 54 for discharging the cooling liquid 60 from the distribution line 28 into the interior of the battery module 100.

The inlet openings 54 are disposed distributed over the battery cells 10 in the stacking direction 26, so that even wetting of the first end faces 16 of the battery cells 10 with cooling liquid 60 can be ensured. The inlet openings 54 are disposed distributed in the stacking direction 26 of the battery cells 10. The connecting elements 12, 14 can thus in particular serve as a baffle element when cooling liquid 60 is being supplied.

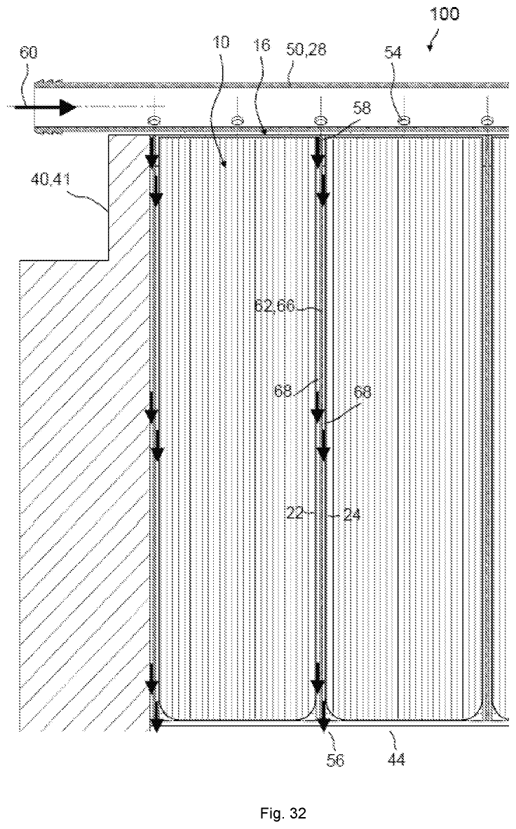

FIG. 31 shows a longitudinal section through the battery module 100 of FIG. 30, while FIG. 32 shows an enlarged detail of the longitudinal section which illustrates the flow of the cooling liquid 60. The cooling liquid 60 flows into the battery module 100 through the fluid supply device 50 configured as a distribution line 28 and escapes through the inlet openings 54 onto the first end face 16 of the battery cells 10. The cooling liquid 60 can be distributed over the first end face 16 and flow through fluid channels 58 between the battery cells 10 to the outlet openings 56 on the underside 44 of the battery module 100. The fluid channels 58 can, for example, be configured as channels 68 in the channel structure 66 shown in FIG. 26, which is disposed as a liquid-permeable layer 62 between the side walls 22, 24 of the battery cells 10.

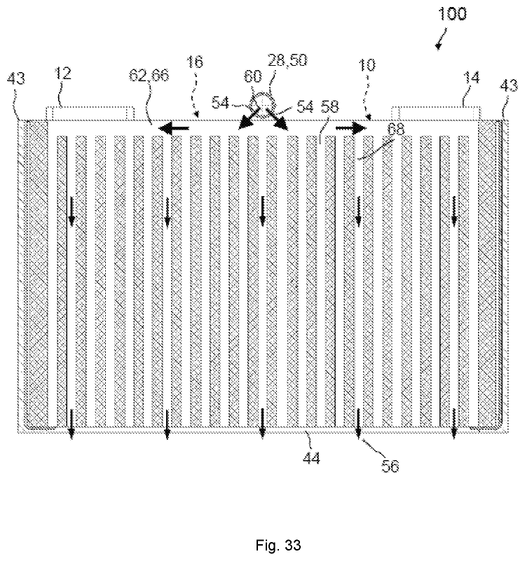

FIG. 33 shows a cross-section through the battery module 100 of FIG. 30 in the region of the channel structure 66. In the cross-section, it can be seen how the cooling liquid 60 flows out of the distribution line 28 through the inlet openings 54 onto the first end face 16 of the battery cells 10 and can be distributed to both sides there on the end face 16 to the connecting elements 12, 14. The end face 16 and the connecting elements 12, 14 can thus be cooled particularly effectively.

The cooling liquid 60 can then flow downward via the channels 68 of the channel structure 66 to the outlet openings 56 of the battery module 100 and freely escape on the underside of the battery module 100.

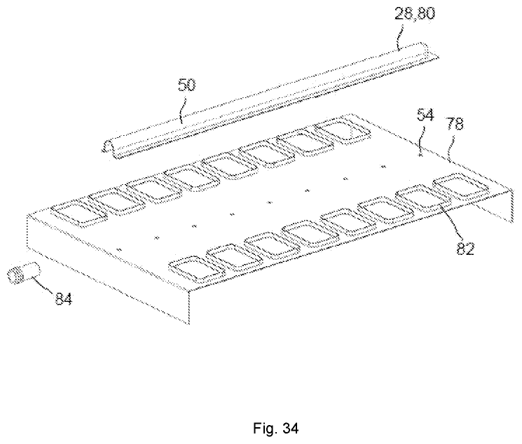

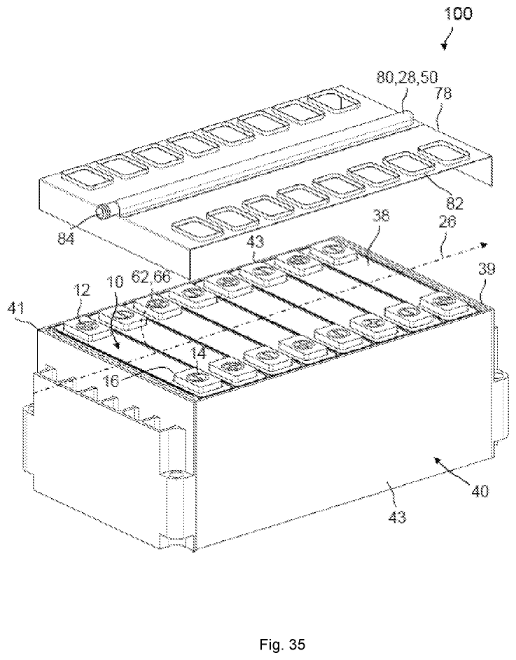

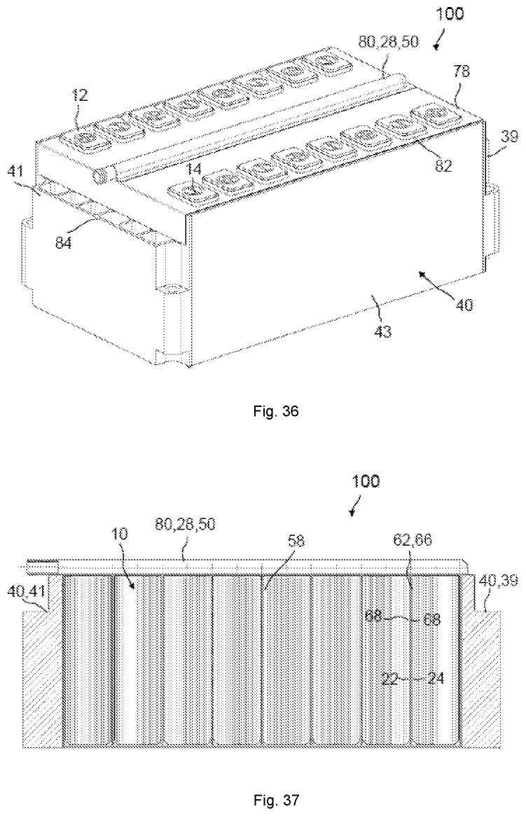

FIG. 34 shows an isometric illustration of a cover 78 comprising a distribution line 28 in exploded view, while FIG. 35 shows an isometric view of a battery module 100 when the cover 78 comprising the distribution line 28 of FIG. 34 is being attached and FIG. 36 shows the battery module 100 with the cover 78 comprising the distribution line 28 attached.

The cover 78 serves to insulate the upper side 42 of the battery module 100 and is disposed on the side of the cell packet 38 comprising the first end faces 16 of the battery cells 10. The cover 78 comprises perforations 82 for the connecting elements 12, 14 of the battery cells 10.

In this design example, the fluid supply device 50 is integrated in the cover 78. To create a channel, a semicircular upper part 80 is placed on the cover 78 that comprises a row of inlet openings 54 distributed along the stacking direction 26 of the battery module 100, thereby forming the distribution line 28. The cooling liquid 60 is fed to the distribution line 28 via a connecting piece 84.

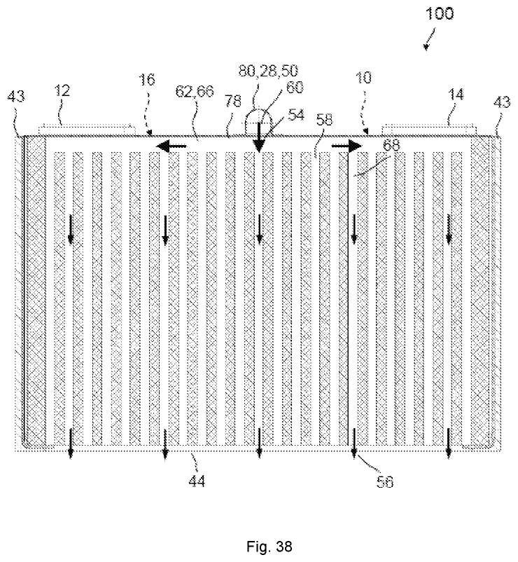

FIG. 37 shows a longitudinal section through the battery module 100 of FIG. 36, while FIG. 38 shows a cross-section through the battery module 100 in the region of the channel structure 66. In the cross-section, it can be seen how the cooling liquid 60 flows out of the distribution line 28 through the inlet openings 54 under the cover 78 onto the first end face 16 of the battery cells 10 and can be distributed to both sides there on the end face 16 to the connecting elements 12, 14.

The end face 16 and the connecting elements 12, 14 can thus be cooled particularly effectively. The cooling liquid 60 can then flow downward via the channels 68 of the channel structure 66 to the outlet openings 56 of the battery module 100 and freely escape on the underside of the battery module 100.

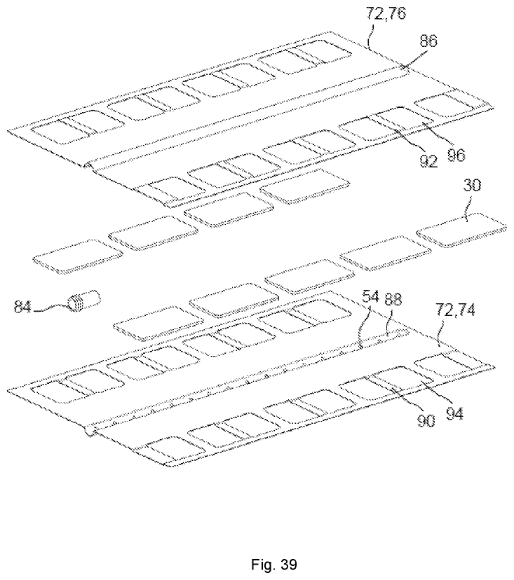

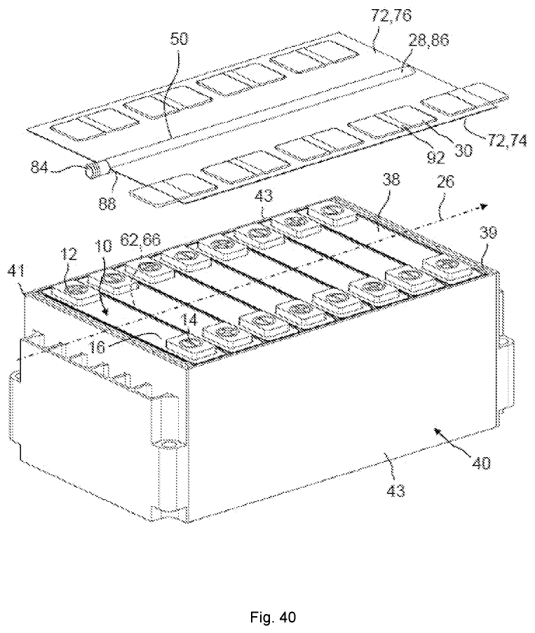

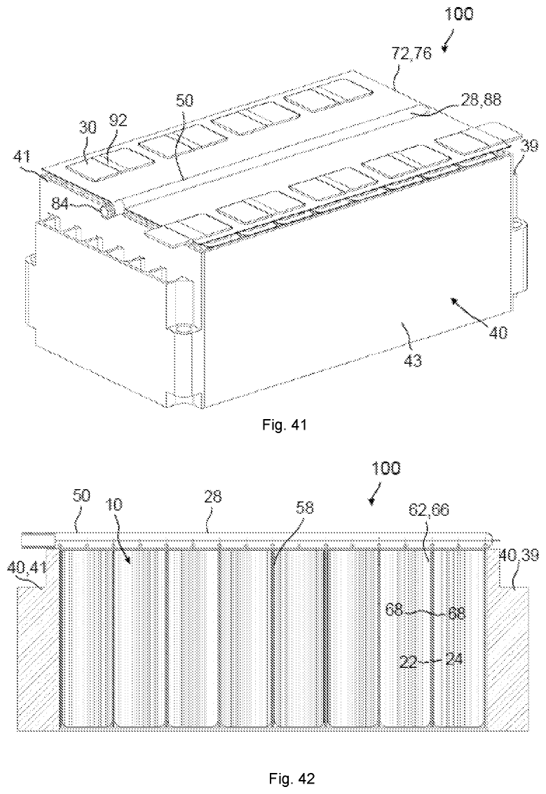

FIG. 39 shows an isometric illustration of a cell connector unit 72 comprising a distribution line 28 in exploded view, while FIG. 40 shows an isometric view of a battery module 100 when the cell connector unit 72 comprising the distribution line 28 is being attached and FIG. 41 shows the battery module 100 with the cell connector unit 72 comprising the distribution line 28 attached.

The cell connector unit 72 is disposed on the side of the cell packet 38 comprising the first end faces 16 of the battery cells 10 and includes the individual cell connectors 30 for electrically connecting the connecting elements 12, 14 in order to connect the battery cells 10 in series and/or in parallel. The cell connectors 30 are used transport current to and from the battery cells. The cell connector unit 72 can comprise further electrical leads for tapping cell voltages for cell voltage monitoring, or for charge equalization between the individual battery cells 10, as well as temperature sensors, for example.

The cell connector unit 72 in FIG. 39 consists of a bottom layer 74 and an upper layer comprising recesses 94, 96 for receiving the cell connectors 30 and webs 90, 92 for fixing the cell connectors 30.

In this design example, the fluid supply device 50 is integrated in the cell connector unit 72. For this purpose, semicircular regions are respectively formed as half shells 86, 88 in the bottom layer 74 and the upper layer 76 in the stacking direction 26 of the cell packet 38 to create a channel. The half shell 88 of the bottom layer 74 comprises inlet openings 54 distributed along the stacking direction 26 for discharging the cooling liquid 60. Joining the bottom layer 74 and the upper layer 76 thus creates the distribution line 28 to which the cooling liquid 60 is fed via a connecting piece 84.

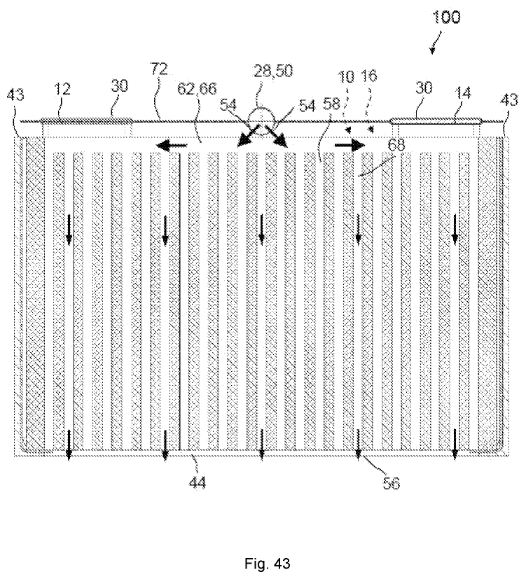

FIG. 42 shows a longitudinal section through the battery module 100 of FIG. 41, while FIG. 43 shows a cross-section through the battery module 100 in the region of the channel structure 66. In the cross-section, it can be seen how the cooling liquid 60 flows out of the distribution line 28 through the inlet openings 54 under the cell connector unit 72 onto the first end face 16 of the battery cells 10 and can be distributed to both sides there on the end face 16 to the connecting elements 12, 14. The end face 16 and the connecting elements 12, 14 can thus be cooled particularly effectively. The cooling liquid 60 can then flow downward via the channels 68 of the channel structure 66 to the outlet openings 56 of the battery module 100 and freely escape on the underside of the battery module 100.

### REFERENCE SIGNS

10 Battery cell
11 Defective battery cell
12 Connecting element
14 Connecting element
16 End face
18 End face
20 Vertical axis
22 Side wall
24 Side wall
26 Stacking direction
28 Distribution line
30 Cell connector
32 Current feed
34 Current feed
36 Elec. lines
38 Cell packet
39 End plate
40 Module casing
41 End plate
42 Upper side
43 Side element
44 Underside
45 Line feedthrough
46 Filling body
50 Fluid supply device
52 Fluid discharge
54 Inlet opening
56 Outlet opening
58 Fluid channel
60 Cooling liquid
62 Layer
64 Adhesive mat
66 Channel structure
68 Channel
70 Blind channel
72 Cell connector unit
74 Bottom layer
76 Upper layer
78 Cover
80 Upper part
82 Perforation
84 Connecting piece
86 Half shell
88 Half shell
90 Web
92 Web
94 Recess
96 Recess
98 Attachment
100 Battery module
200 Battery
202 Fluid inlet
204 Fluid outlet
206 Collecting chamber
208 Fluid Line
210 Battery housing
212 Lower part of the housing
214 Upper part of the housing
216 Housing flange
218 Housing base
220 Fluid channel
222 Opening
224 Fluid conducting element
226 Filling body
228 Battery electronics unit
230 Vertical axis
232 Fluid circuit
234 Cooling device
236 Air separator
240 Pump
242 Cooling liquid line
244 Control line

1.-29. (canceled)

30. A directly cooled battery module comprising:
at least one module casing and a plurality of battery cells disposed inside of the module casing, wherein the module casing encloses the plurality of battery cells at least in some regions, wherein the battery cells comprise a vertical axis and first and second end faces which are spaced apart from one another in the direction of the vertical axis, and wherein the battery cells are disposed successively in the form of a cell packet in a stacking direction that is transverse to the vertical axis, and
a fluid supply device having (i) at least one inlet opening which is configured to conduct a cooling liquid onto the battery cells, and (ii) at least one outlet opening that is configured for freely discharging the cooling liquid from the module casing and/or the cell packet into surroundings of the module casing.

31. The directly cooled battery module according to claim 30, wherein at least one fluid channel is disposed inside of the module casing in an end plate between the first end face and the second end face of the battery cells.

32. The directly cooled battery module according to claim 31, wherein the at least one inlet opening is disposed in the end plate at a location near an underside of the module casing.

33. The directly cooled battery module according to claim 31, wherein the at least one outlet opening is disposed on the underside of the module casing.

34. The directly cooled battery module according to claim 30, wherein the fluid supply device further comprises a distribution line having a plurality of the inlet openings, wherein the fluid supply device comprises at least one inlet opening per electrical connecting element of the battery cells, and/or
wherein the fluid supply device further comprises a plurality of the outlet openings.

35. The directly cooled battery module according to claim 30, wherein the fluid supply device is configured for targeted distribution of the cooling liquid over at least one of the two end faces of the battery cells in the cell packet, and wherein the fluid supply device is configured for targeted distribution of the cooling liquid over the electrical connecting elements of the battery cells in the cell packet.

36. The directly cooled battery module according to claim 30, wherein the fluid supply device comprises a nozzle assembly that is configured to spray the cooling liquid onto the cell packet.

37. The directly cooled battery module according to claim 30, wherein at least one fluid channel is disposed inside of the module casing between the first end face and the second end face of the battery cells in the cell packet.

38. The directly cooled battery module according to claim 30, wherein a liquid-permeable layer, in the form of a porous adhesive mat, is disposed at least partly between the battery cells in the direction of the vertical axis, or
wherein the fluid supply device comprises a channel structure including channels that extend from one end face to the other end face of the battery cells in the cell packet, wherein the channels are continuous blind channels in at least in some regions.

39. The directly cooled battery module according to claim 30, wherein the inlet openings for the cooling liquid are directed toward the first end faces such that the cooling liquid can escape from the inlet openings onto the first end faces and the outlet openings are disposed on the opposite side of the cell packet with respect to the vertical axis.

40. The directly cooled battery module according to claim 30, wherein the inlet openings are directed toward the second end faces such that the cooling liquid can escape from the inlet openings onto the second end faces and the outlet openings are disposed on the opposite side of the cell packet with respect to the vertical axis.

41. The directly cooled battery module according to claim 30, wherein, with respect to the vertical axis, the fluid supply device is disposed on a side of the cell packet that comprises the first end faces or on a side of the cell packet that comprise the second end faces.

42. The directly cooled battery module according to claim 41, wherein the outlet openings are disposed laterally in the module casing at a height of the vertical axis between the first and second end faces of the battery cells in the cell packet.

43. The directly cooled battery module according to claim 30, wherein the module casing is configured as a wall which extends around the vertical axis of the cell packet, wherein the wall is in the form of a band or frame.

44. The directly cooled battery module according to claim 30, wherein the module casing comprises a wall which extends around the vertical axis of the cell packet and at least one at least substantially closed upper side on a side of the cell packet comprising the first end faces,
wherein the fluid supply device is disposed on a side of the cell packet that comprises the second end faces, and
wherein the outlet opening is disposed on the upper side.

45. The directly cooled battery module according to claim 30, wherein the outlet opening has a cross-section which is configured such that a higher pressure loss for the cooling liquid occurs at the outlet opening than at the inlet opening and in a further course of a flow of the cooling liquid between the inlet opening and the outlet opening.

46. The directly cooled battery module according to claim 30, further comprising filling bodies disposed in an interior of the module casing, and in a region of the fluid supply device and/or a fluid discharge.

47. The directly cooled battery module according to claim 30, further comprising a cell connector unit and/or a cover that is disposed on a side of the cell packet comprising the first end faces of the battery cells, wherein the fluid supply device is integrated in the cell connector unit and/or the cover.

48. The directly cooled battery module according to claim 30, wherein the fluid supply device (i) is disposed on one of the end faces between oppositely disposed electrical connecting elements of a battery cell, and/or (ii) comprises the distribution line having a plurality of the inlet openings, wherein the inlet openings are distributed over the battery cells in the stacking direction.

49. The directly cooled battery module according to claim 30, wherein the fluid supply device (i) is disposed on the module casing near one of the end faces and/or (ii) comprises the distribution line having a plurality of the inlet openings, wherein the inlet openings are distributed over battery cells in the stacking direction.

50. The directly cooled battery module according to claim 30, wherein the fluid supply device (i) is disposed on the module casing on the first end faces at a height of electrical connecting elements of a battery cell, wherein the connecting elements serve as a baffle element when cooling liquid is being supplied and/or (ii) comprises the distribution line having a plurality of the inlet openings, wherein the inlet openings are distributed in the stacking direction of the battery cells.

51. A battery comprising (i) the directly cooled battery module according to claim 30, and (ii) a battery housing having a fluid-tight lower part,
wherein the battery housing comprises a fluid inlet and at least one fluid outlet for cooling liquid, wherein the fluid inlet is fluidically connected to the fluid supply device of the directly cooled battery module, wherein the battery housing comprises at least one collecting chamber for collecting the cooling liquid that has freely escaped from the directly cooled battery module.

52. The battery according to claim 51, wherein the lower part of the housing comprises integrated fluid channels in the form of suction channels for discharging the cooling liquid, wherein the fluid channels are fluidically connected to the collecting chamber via openings.

53. The battery according to claim 51, wherein the battery housing comprises fluid conducting elements disposed along the vertical axis.

54. The battery according to claim 51, further comprising filling bodies disposed in an interior of the battery housing between adjacent battery modules.

55. The battery according to claim 51, wherein the fluid inlet and the fluid outlet are connected via a closed fluid circuit comprising at least one of a cooling device, a heat exchanger, and an air separator.

56. The battery according to claim 51, wherein at least one battery management system and/or switching components is/are integrated into the battery housing.

57. The battery according to claim 51, wherein the battery housing comprises a module casing of the directly cooled battery module, and wherein the lower part of the housing is configured as a collecting chamber for the cooling liquid that has freely escaped from the directly cooled battery module, wherein a housing base of the lower part of the housing comprises openings for the cooling liquid to enter the collecting chamber.

58. The battery according to claim 57, wherein the lower part of the housing comprises fluid channels for discharging the cooling liquid.
